(19) United States
(12) Patent Application Publication
(10) Pub. No.: US 2011/0193260 A1
(43) Pub. Date: Aug. 11, 2011

(54) CELLULOSE ACETATE FILM AND METHOD FOR PRODUCING IT, POLARIZER AND LIQUID CRYSTAL DISPLAY DEVICE

(75) Inventors: Jun TAKEDA, Minami-ashigara-shi (JP); Yoshiaki HISAKADO, Minami-ashigara-shi (JP); Akiko WATANO, Minami-ashigara-shi (JP); Yoshio ISHII, Fujinomiya-shi (JP); Yu NAITO, Minami-ashigara-shi (JP); Nobutaka FUKAGAWA, Minami-ashigara-shi (JP)

(73) Assignee: FUJIFILM CORPORATION, Tokyo (JP)

(21) Appl. No.: 13/022,429

(22) Filed: Feb. 7, 2011

(30) Foreign Application Priority Data
Feb. 10, 2010 (JP) 2010-027608
Mar. 5, 2010 (JP) 2010-048891
Mar. 11, 2010 (JP) 2010-054051

(51) Int. Cl. B29D 7/01; C09D 101/12

(52) U.S. Cl. 264/213; 106/171.1; 264/217

(57) ABSTRACT

A method for producing a cellulose acetate film including casting a dope containing a cellulose acetate having a total substitution degree of from 2.0 to 2.7 and a solvent on a support, and peeling away the obtained dope film from the support.

### BACKGROUND OF THE INVENTION

1. Field of the Invention

The present invention relates to a cellulose acetate film and a method for producing cellulose acetate film. The present invention also relates to a polarizer and a liquid crystal device produced by the use of the cellulose acetate film.

2. Description of the Related Art

Heretofore, various optical films are used in liquid crystal display devices, and optical films with various additives added thereto are known. Such optical films are produced in various production methods. One typical method widely employed in the art is a solution casting method that comprises casting a dope prepared by dissolving a cellulose acylate in a solvent onto a support for film formation thereon.

Recently, from the viewpoint of inexpensively producing a film having a retardation Rth in the thickness direction thereof, it has become investigated to employ a cellulose diacylate having a low degree of total acyl substitution. At present, however, in producing a film of cellulose diacetate having a low degree of total acyl substitution by solution casting, a method for improving the peeling property of the film from the support is not as yet satisfactorily investigated.

JP-A 2009-263619 discloses a technique of controlling the water content of a cellulose acetate dope before solution casting, in which the cellulose acetate has a low degree of total acyl substitution of from 2.1 to 2.7, to fall within a specific range and controlling the Δsp value (solubility parameter) between cellulose acetate and solvent to fall within a specific range to thereby prevent the obtained film from being whitened. In the patent reference, in controlling the Δsp value of the solvent, the compositional ratio of the solvent methylene chloride/methanol is varied to be at most 70/30 (by mass) to prevent the film from being whitened; however, in this, nothing is investigated relating the peeling property of the film. Further, the patent reference shows no Example of using a primary alcohol having at least 2 carbon atoms, but rather says that methanol is the most preferred as the solvent.

In Examples in the patent reference, used is a citric acid half-ester as the release agent (release promoter).

On the other hand, heretofore, in producing a film of cellulose triacetate having a high degree of total acyl substitution by solution casting, some methods have been investigated for improving the peeling property of the film from a support. For example, JP-A 61-148013 describes a technique of co-casting at least two layers of a cellulose triacetate having a high degree of total acyl substitution, in which the dope is dried on a support for facilitating its gellation and then the dope is gelled on the support in such a controlled manner that the temperature of the dope and the support is made to be not higher than 20° C. in the region where the formed film is released, thereby promoting the film formation speed. However, the principle of the method described in the patent reference is that, while the casting thickness of the dope for the layer on the side of the support, of which the solvent composition is controlled to be relatively easily releasable from the support, is at least 5 μm and while the dope is co-cast with the other dope of the other layer having a relatively easily evaporable solvent composition, the defined temperature profile is secured to thereby prevent the dope of the layer on the support side from being mixed with the dope of the other layer; and therefore, the patent reference does neither suggest nor disclose the matter as to whether or not the drying and cooling in releasing the film could be an effective method for widely improving the peeling property of a single-layer film. In addition, the patent reference says that the dope is gelled under such a controlled condition that the temperature of the dope and the support is made to be not higher than 20° C. in the region where the formed film is released; however, in Examples therein, any concrete investigation is not made relating to the cooling temperature in releasing the formed film, and in addition, any concrete range is neither disclosed nor suggested for the residual solvent amount to be in the film. Further, nothing is referred to in the patent reference relating to an example of lowering the degree of total acyl substitution of the cellulose ester used therein.

On the other hand, recently, from the viewpoint of inexpensively producing a film having a retardation Rth in the thickness direction thereof, it has become investigated to employ a cellulose diacetate having a low degree of total acyl substitution. At present, however, in producing a film of cellulose diacetate having a low degree of total acyl substitution by solution casting, a method for improving the peeling property of the film from the support is not as yet satisfactorily investigated.

JP-A 2009-263619 discloses a case of investigating the production condition in producing a film of cellulose diacetate having a low degree of total acyl substitution by solution casting. The reference describes a method of reducing the haze of the film to be obtained by varying the compositional ratio of the solvent, dichloromethane/methanol for dissolving cellulose diacetate therein and by controlling the solubility parameter of additives and cellulose diacetate. However, in the reference, nothing is investigated relating to the peeling property of the film from the support. In addition, in Examples in the reference, no investigation is made relating to the concrete cooling temperature in releasing the film, and the concrete range of the residual solvent amount is neither disclosed nor suggested.

### SUMMARY OF THE INVENTION

The present inventors produced a film of cellulose diacetate (hereinafter this may be referred to as DAC) having a low degree of total acyl substitution by solution casting, and have known that, as compared with that in the case of using a cellulose triacetate having a high degree of total acyl substitution, the Rth expressibility could be good but the film peeling property from the support is more difficult.

In this connection, the inventors tried producing a film of a relatively expensive cellulose acetate propionate having a degree of total acyl substitution of from 2.0 to 2.7 or so and having a propionyl group as the acyl group in some degree (hereinafter this maybe referred to as CAP) by solution casting, and have surprisingly found that the film has better peeling property than the inexpensive cellulose diacetate film having the same degree of total acyl substitution but having an acetyl group alone as the acyl group.

Not adhering to any theory, the difference in peeling property from support between CAP and DAC both having the same level of hydroxyl group amount would be because, since the side chain, propionyl chain of the cellulose acetate is longer than the acetyl chain, the distance between the support and the unsubstituted hydroxyl group could be longer and therefore the interaction between the support and the hydroxyl group could reduce and the releasing load could be thereby reduced.

Accordingly, the inventors have known that the problem of how to improve the peeling property of film from support when the degree of total acyl substitution is lowered is a problem intrinsic to DAC.

Given the situation, the inventors have started assiduous studies for improving the peeling property of film from support intrinsic to solution casting in film production by the use of a cellulose diacetate having a low degree of total acyl substitution which is more inexpensive than CAP and for which the production cost is lower.

In this connection, the inventors tried producing a film of cellulose diacetate having a low degree of total acyl substitution by solution casting, and have known that, as compared with that in the case of using a cellulose triacetate having a high degree of total acyl substitution, the Rth expressibility could be good but the film peeling property from the support is more difficult. Accordingly, the inventors made assiduous studies for the purpose of improving the film peeling property from support in solution casting in film production by the use of a cellulose diacetate having a low degree of total acyl substitution. Specifically, the problem that the invention is to solve is how to provide a production method for a cellulose acetate film having good Rth expressibility and capable of being readily released from the support in solution casting.

With the above-mentioned problems, the present inventors have assiduously studied the peeling property of cellulose acetate film and, as a result, have found that, when a solvent of alcohols having a mean carbon number falling within a specific range, as mixed in a specific ratio, is used as the solvent for the dope of the cellulose acetate, then the formed film could be well released from the support, and have completed the first aspect of the invention.

On the other hand, also with the above-mentioned problems, the inventors have further assiduously studied the peeling property of cellulose acetate film having a low degree of total acyl substitution and, as a result, have found that, in the solution casting process, when a cooling unit having a temperature falling within a specific range is kept in contact with the support that moves in contact with the film formed and to be released, on the side of the support opposite to the side thereof from which the formed film is to be released, to thereby control the amount of the residual solvent in the film so as to fall within a specific range, then the peeling property of the film could be bettered and the film could be well released from the support, and have completed the second aspect of the invention.

Concretely, the above-mentioned problems have been solved by the following means.
[1] A method for producing a cellulose acetate film comprising casting a dope comprising a cellulose acetate and a solvent on a support to prepare a dope film, wherein the total substitution degree of the cellulose acetate is from 2.0 to 2.7; and peeling away the dope film from the support.
[2] The method for producing a cellulose acetate film of [1], wherein the solvent comprises an alcohol in an amount of 15% or more by mass and the average carbon number of the alcohol is from 1.5 to 4.
[3] The method for producing a cellulose acetate film of [2], wherein the alcohol comprises ethanol.
[4] The method for producing a cellulose acetate film of [2] or [3], wherein the support is a strip-shaped support, and in the region where the dope film is peeled away from the support, the support is kept in contact with a cooling unit having a surface temperature of 10° C. or lower, on the side thereof opposite to the side from which the dope film is peeled away.
[5] The method for producing a cellulose acetate film of [1], wherein the residual solvent amount is controlled to be at most 100% at the time when the dope film is peeled away, and in the region where the dope film is peeled away from the support, the support is kept in contact with a cooling unit having a surface temperature of 10° C. or lower, on the side thereof opposite to the side from which the dope film is peeled away.
[6] The method for producing a cellulose acetate film of [5], wherein the total substitution degree of the cellulose acetate is from 2.1 to 2.6.
[7] The method for producing a cellulose acetate film of [6], wherein the residual solvent amount is controlled to be at most 55% at the time when the dope is peeled away from the support.
[8] The method for producing cellulose acetate film of any one of [5] to [7], wherein the surface temperature of the cooling unit is −5° C. or lower.
[9] The method for producing cellulose acetate film of any one of [5] to [8], wherein the dope comprises at least one alcohol having 2 or more carbon atoms as the solvent, and the total content of the alcohol to the total mass of the solvent is from 10 to 40% by mass.
[10] The method for producing a cellulose acetate film of any one of [5] to [9], wherein the dope comprises ethanol as the solvent, and the total content of the ethanol to the total mass of the solvent is from 10 to 40% by mass.
[11] The method for producing cellulose acetate film of any one of [1] to [10], wherein the dope includes a release promoter.
[12] The method for producing a cellulose acetate film of [11], wherein the release promoter is an organic acid represented by the following formula (1) and the content of the release promoter to the cellulose acetate in the dope is from 0.001 to 20% by mass:

X-L-(R¹)ₙ Formula (1)

wherein X represents an acid group wherein the acid dissociation constant is 5.5 or less; L represents a single bond, or a di- or more valent linking group; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms or a hetero ring group having from 6 to 30 carbon atoms, and each group may have a substituent; n represents 1 in the case where L is a single bond, or represents the number expressed by:

(the valence number of L)−1

in the case where L is di- or more valent linking group.
[13] The method for producing a cellulose acetate film of [12], wherein the X in the formula (1) represents a carboxyl group, a sulfonic acid group, a sulfinic acid group, a phosphate group, a sulfonimide group or an ascorbic acid group.
[14] The method for producing a cellulose acetate film of any one of [1] to [13], wherein the dope comprises an agent for controlling Rth that is the retardation in the thickness direction of the film.
[15] The method for producing a cellulose acetate film of any one of [1] to [14], further comprising stretching the film at a temperature satisfying the following inequality (1):

Te−30° C.≦Stretching temperature≦Te+30° C. (1),

Te=T[tan δ]−ΔTm (1′),

ΔTm=Tm(0)−Tm(x): (1″),

wherein T[tan δ] represents the temperature at which tan δ shows a peak in measurement of the dynamic viscoelasticity tan δ of cellulose acetate having a residual solvent amount of 0%; Tm(0) represents the crystal melting temperature of the cellulose acetate having a residual solvent amount of 0%; and Tm(x) represents the crystal melting temperature of the cellulose acetate having a residual solvent amount of x %.
[16] A cellulose acetate film produced by the method for producing a cellulose acetate film of any one of [1] to [15], having an Rth, that is a retardation in the thickness direction of the film, measured at the wave length of 590 nm is 80 nm or more.
[17] The cellulose acetate film of [16], having a haze of less than 0.5%.
[18] The cellulose acetate film of [16] or [17], having an Re, that is an in-plane retardation, measured at the wave length of 590 nm is from 30 to 100 nm.
[19] A polarizer comprising a polarizing element and at least one sheet of the cellulose acetate film of any one of [16] to [18].
[20] A liquid crystal display device comprising at least one sheet of the cellulose acetate film of any one of [16] to [18].

According to the invention, the invention provides a method for producing a cellulose acylate film, which attains easy peeling from the support after a solvent casting and a good Rth expression.

### BRIEF DESCRIPTION OF THE DRAWING

FIG. 1 is a schematic view showing an embodiment of a preferred solution casting apparatus having an endless belt hung to run between two rolls, in which the solution casting and peeling condition in the production method of the invention is controlled.

In the drawing, 101 denotes endless metal belt, 102 denotes driven roll, 103 denotes driving roll (cooling unit), 104 denotes gear pump, 105 denotes T-die, 106 denotes take-up roll group, 107 denotes peeling region, 108 denotes residual solvent amount control unit, 109 denotes roll cooling device, 110 denotes belt meandering preventing device.

### BEST MODE FOR CARRYING OUT THE INVENTION

Description will now be made in detail of the present invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted. In the invention, “mass %” is equal to “weight %”, and “% by mass” is equal to “% by weight”.

### [Method for Producing Cellulose Acetate Film]

The method for producing cellulose acetate film of the invention (which is also referred to as the producing method of the invention hereinafter) includes casting a dope comprising a cellulose acetate and a solvent on a support to prepare a dope film, wherein the total substitution degree of the cellulose acetate is from 2.0 to 2.7; and peeling away the dope film from the support.

The first embodiment of the method for producing a cellulose acetate film includes casting a dope having a cellulose acetate and a solvent on a support to prepare a dope film, wherein the total substitution degree of the cellulose acetate is from 2.0 to 2.7; and peeling away the dope film from the support. The solvent comprises an alcohol in an amount of 15% or more by mass, and the average carbon numbers of the alcohol is from 1.5 to 4.

The second embodiment of the method for producing a cellulose acetate film includes controlling the residual solvent amount at the time of peeling away the dope film from the support to at most 100%. In the region where the dope film is peeled away from the support, the support is kept in contact with a cooling unit having a surface temperature of 10° C. or lower, on the side thereof opposite to the side from which the dope film is peeled away.

Hereinafter describes the producing method of the invention.

The cellulose acetate film of the invention is produced according to a solvent-casting method. Examples of production of cellulose acetate film according to a solvent-casting method are given in U.S. Pat. Nos. 2,336,310, 2,367,603, 2,492,078, 2,492,977, 2,492,978, 2,607,704, 2,739,069 and 2,739,070, British Patents 640731, 736892, JP-B 45-4554, 49-5614, and JPA Nos. syo 60-176834, syo 60-203430, and syo 62-115035, and their descriptions are referred to herein. The cellulose acetate film may be stretched. Regarding the method and condition for stretching treatment, for example, referred to are JPA Nos. syo 62-115035, hei 4-152125, hei 4-284511, hei 4-298310, and hei 11-48271.

<Preparing Dope>

In the solvent casting method, film can be produced from a solution (dope) of cellulose acetate in an organic solvent.

### (Dope)

The dope used in the producing method of the invention contains cellulose acetate of which the total substitution degree is from 2.0 to 2.7 and a solvent. Using such a dope, a cellulose acetate film having a highly expressed Rth can be obtained. Hereinafter described are the dope for use in production of the film of the invention and ingredients contained in the dope.

### (Cellulose Acetate)

The cellulose acetate used in the invention is not specifically limited so long as the total substitution degree is from 2.0 to 2.7. It is preferable that the total substitution degree of the cellulose acetate is from 2.0 or more because its compatibility with water is sufficiently high and the obtained film is not tend to be whitened. Cellulose used as a starting material in preparation for the cellulose acetate used in the invention includes cotton linter and wood pulp (broadleaf pulp, coniferous pulp), etc. Any cellulose acetate obtained from any of such a starting cellulose may be used. As the case may be, a mixture of different cellulose acetates may also be used herein. The details of the cellulose as a starting material are described, for example, in “Plastic Material Lecture (17), Cellulosic Resin” (written by Marusawa, Uda, published by Nikkan Kogyo Shinbun-sha, 1970); and Hatsumei Kyokai Disclosure Bulletin 2001-1745 (pp. 7-8).

Description will first be made in detail of the cellulose acetate preferably used for the purpose of the invention. The glucose units having a .beta.-1, 4 bond and forming the cellulose have free hydroxyl groups in the 2-, 3- and 6-positions thereof. The cellulose acylate is a polymer obtained by esterifying a part or all of those hydroxyl groups with an acyl group. Its acyl substitution degree means the total of the esterification degrees of cellulose in the 2-, 3- and 6-positions (an esterification degree of 100% meaning a substitution degree of 1). In the first embodiment of the present invention, the total degree of acyl substitution, i.e., DS2+DS3+DS6, is preferably from 2.1 to 2.55, more preferably from 2.2 to 2.55, particularly preferably from 2.35 to 2.50, more particularly preferably from 2.40 to 2.50. In the second embodiment of the present invention, the total degree of acyl substitution, i.e., DS2+DS3+DS6, is preferably from 2.1 to 2.6, more preferably from 2.40 to 2.50, particularly preferably from 2.35 to 2.55, more particularly preferably from 2.40 to 2.50.

DS6/ (DS2+DS3+DS6) is preferably from 0.08 to 0.66, more preferably from 0.15 to 0.60, particularly preferably from 0.20 to 0.45. In the invention, DS2 represents a degree of acyl group substitution in the 2-position hydroxyl group of a glucose unit (hereinafter referred to as “the degree of acyl substitution in 2-position”); DS3 represents a degree of acyl group substitution in the 3-position hydroxyl group of a glucose unit (hereinafter referred to as “the degree of acyl substitution in 3-position”); DS6 represents a degree of acyl group substitution in the 6-position hydroxyl group of a glucose unit (hereinafter referred to as “the degree of acyl substitution in 6-position”). Moreover, DS6/(DS2+DS3+DS6) is a ratio of the degree of acyl substitution in the 6-position to the total acyl substitution degree, and also hereinafter referred to as “acyl substitution ratio of 6-position”.

The acyl group of the cellulose acetate for use in the dope is acetyl group.

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a fatty acid ester of cellulose comprises acylating cellulose with a fatty acid corresponding to an acetyl group (e.g., acetic acid), or with an organic acid ingredient containing its acid anhydride.

The cellulose acetate for use in the invention can be produced, for example, according to the method described in JP-A 10-45804.

The amount of the cellulose acetate in the dope for use in the invention is preferably from 10 to 40% by mass, more preferably from 10 to 30% by mass.

### (Solvent)

Any known solvents used in solvent casting can be used as the solvent in the invention. From the viewpoint of decreasing the haze, it is preferable that the organic solvent includes at lest one selected from ethers having from 3 to 12 carbon atoms, ketones having from 2 to 12 carbon atoms, esters having from 3 to 12 carbon atoms, and halogenohydrocarbons having from 1 to 6 carbon atoms. The esters, the ketones and the ethers may have a cyclic structure. Compounds having two or more functional groups of esters, ketones and ethers (i.e., —O—, —CO— and —COO—) are also usable herein as a main solvent; and they may have any other functional group such as an alcoholic hydroxyl group. In the case where the main solvent has two or more functional groups, the number of the carbon atoms constituting them may fall within a range of the number of carbon atoms that constitute the compound having any of those functional groups.

Examples of the ethers having from 3 to 12 carbon atoms are diisopropyl ether, dimethoxymethane, dimethoxyethane, 1,4-dioxane, 1,3-dioxolane, tetrahydrofuran, anisole and phenetole.

Examples of the ketones having from 3 to 12 carbon atoms are acetone, methyl ethyl ketone, diethyl ketone, diisobutyl ketone, cyclohexanone, and methylcyclohexanone.

Examples of the esters having from 3 to 12 carbon atoms are ethyl formate, propyl formate, pentyl formate, methyl acetate, ethyl acetate, and pentyl acetate.

Examples of the organic solvents having plural functional groups are 2-ethoxyethyl acetate, 2-methoxyethanol, and 2-butoxyethanol.

The halogenated hydrocarbon preferably has one or two carbon atoms, and more preferably has one carbon atom. The halogen atom of the halogenated ° hydrocarbon preferably is chlorine. The ratio of the substitution of hydrogen with halogen is preferably in the range of 25 to 75 mol %, more preferably in the range of 30 to 70 mol %, further preferably in the range of 35 to 65 mol %, and most preferably in the range of 40 to 60 mol %.

Examples of the halogenohydrocarbons are dichloromethane (hereinafter referred to as methylene chloride), chloroform, methyl chloride, carbon tetrachloride, trichloroacetic acid, methyl bromide, methyl iodide, trichloroethylene, tetrachloroethylene, etc., and it is preferable that the dope comprises dichloromethane.

Preferably, in the invention, the solvent contains a poor solvent in a ratio of from 3 to 40% by weight, more preferably from 5 to 20% by weight. Containing a poor solvent in the ratio as above, the solubility of cellulose acetate in the solvent preferably increases and the haze of the formed film could lower.

Preferably, the boiling point of the poor solvent is not higher than 120° C., more preferably from 40 to 100° C. Having a boiling point not higher than 120° C., the solvent is preferred as the drying speed could be high.

Preferred examples of the poor solvent include alcohols (methanol, ethanol, n-propanol, isopropanol, n-butanol, isobutanol, n-pentanol, n-hexanol) and water. Above all, for the production method of the invention, preferred is use of a primary alcohol (methanol, ethanol, n-propanol, n-butanol, n-pentanol, n-hexanol), and most preferred is use of ethanol from the viewpoint of satisfying both the peeling property and the drying speed.

In the first aspect of the production method of the invention, an alcohol (preferably a primary alcohol) accounts for at least 15% by mass of the solvent in the dope, and the alcohol has a mean carbon number of from 1.5 to 4.

The primary alcohol having a carbon number of at least 2 includes ethanol, n-propanol, isopropanol, n-butanol, isobutanol, n-pentanol, n-hexanol, etc. Of those, preferred are ethanol, n-propanol, isopropanol, n-butanol, isobutanol. The primary alcohol as referred to herein may include glycols such as a polyalcohol having at least 3 carbon atoms; however, ethylene glycol that is a glycol having 2 carbon atoms is not a primary alcohol.

So far as the mean carbon number of the alcohol to be in the dope is from 1. 5 to 4, two or more different types of alcohols may be used as combined. Further so far as the mean carbon number of the alcohol is from 1.5 to 4, the alcohol may contain methanol having 1 carbon atom or an alcohol having 5 or more carbon atoms. Concretely, ethanol that is an alcohol having 2 carbon atoms and methanol having 1 carbon atom may be mixed in a ratio ethanol/methanol of at least 1/1 (by mass), and the resulting mixed solvent may be used here.

The carbon number of the alcohol to be in the solvent in the dope in a ratio of at least 15% by mass is preferably from 1.5 to 4, more preferably from 1.5 to 2.5, even more preferably from 1.5 to 2.

The content of the alcohol to be in the dope as the solvent is preferably from 18 to 40% by mass of the solvent from the viewpoint of more improving the film peeling property, more preferably from 20 to 30% by mass.

Preferably, the total content of the alcohol having at least 2 carbon atoms to the total mass of the solvent is from 10 to 40% by mass.

More preferably, the total content of the alcohol having at least 2 carbon atoms to the total mass of the solvent is at least 10% by mass from the viewpoint of further improving the film peeling property, even more preferably from 15 to 40% by mass, still more preferably from 20 to 30% by mass.

In the second aspect of the production method of the invention, the solvent (poor solvent) in the dope contains at least one alcohol (preferably a primary alcohol) having at least 2 carbon atoms, from the viewpoint of preventing the formed film from whitening.

Preferably in the production method of the invention, the total content of the alcohol having at least 2 carbon atoms to the total mass of the solvent is from 10 to 40% by mss.

More preferably, the total content of the alcohol having at least 2 carbon atoms to the total mass of the solvent is at least 10% by mass from the viewpoint of more improving the film peeling property, even more preferably from 10 to 40% by mass, still more preferably from 12 to 35% by mass, further more preferably from 15 to 30% by mass.

Preferably, the boiling point of the alcohol having at least 2 carbon atoms is not higher than 120° C., more preferably from 40 to 100° C. Having a boiling point not higher than 120° C., the alcohol is preferred as the drying speed of the solvent could be high.

Containing the alcohol having at least 2 carbon atoms in the amount falling within the above range, the solubility of cellulose acetate in the solvent preferably increases and the haze of the formed film could lower.

Specifically in the second aspect of the production method of the invention, preferably, the dope contains at least ethanol as the solvent and the total content of ethanol to the total mass of the solvent is from 10 to 40% by mass.

### (Additive)

The film of the invention may contain various additives such as release promoter, Rth controlling agent (including non-phosphate ester compound), inorganic fine particles (mat agent), phthalate, plasticizer such as phthalate or phosphate compound, Re enhancer, UV absorbent, antioxidant, etc.

### (1) Release Promoter

In the method for producing the film of the invention, the dope preferably contains a release promoter from the viewpoint of improving the releasing property. The release promoter may be contained, for example, in an amount of from 0.001% by mass (10 ppm) to 20% by mass (200000 ppm) , preferably in an amount of from 50 ppm to 15% by mass (150000 ppm), more preferably in an amount of from 100 ppm to 10% by mass (100000 ppm), particularly preferably in an amount of from 0.03% by mass (300 ppm) to 10% by mass (100000 ppm), more particularly preferably in an amount of from 0.1% by mass (1000 ppm) to 5% by mass (50000 ppm), relative to the amount of the cellulose acetate contained in the dope.

As the release promoter, the compounds described in JP-A 2006-45497, [0048] to [0069] may be preferably used herein. These compounds and other examples of the release promoter preferably used in the producing method of the invention are explained hereinafter.

The release promoter is preferably an organic acid, a polycarboxylate ester, a surfactant or a chelating agent.

As the polycarboxylate ester, preferred are the compounds described in JP-A 2006-45497₄ paragraph [0049].

As the surfactant, preferred are the compounds described in JP-A 2006-45497, paragraphs [0050] to [0051].

The chelating agent is a compound capable of being chelated with a polyvalent ion such as an iron ion or the like metal ion or a calcium ion or the like alkaline earth metal ion. As the chelating agent, usable here are the compounds described in JP-B 6-8956 and JP-A 11-190892.

As the organic acid, preferred are those represented by the following formula (1).

Organic acids of formula (1) preferred as the release promoter in the invention are described in detail hereinunder.

X-L-(R¹)ₙ Formula (1)

wherein X represents an acid group having an acid dissociation constant of 5.5 or less; L represents a single bond or di- or more valent linking group; R¹ represents an alkyl group having from 6 to 30 carbon atoms, an alkenyl group having from 6 to 30 carbon atoms, an alkynyl group having from 6 to 30 carbon atoms, an aryl group having from 6 to 30 carbon atoms or a hetero ring group having from 6 to 30 carbon atoms, and these groups may have a substituent; n represents 1 in the case where the L is a single bond, or represents the number expressed by:

(the valence number of L)−1

in the case where the L is di- or more valent linking group.

In the formula (1), X represents an acid group having an acid dissociation constant of 5.5 or less, preferably a carboxyl group, a sulfonic acid group, a sulfinic acid group, a phosphoric acid group, a sulfonimide group or an ascorbic acid group, more preferably a carboxyl group or a sulfonic acid group, most preferably a carboxyl group. In the case where X represents an ascorbic acid group, the 5 and 6-positioned hydrogen atoms of the ascorbic acid group are preferably removed and the group bonds to L.

In this description, the data given in “Handbook of Chemistry” published by Maruzen may be employed for the acid dissociation constant.

In the formula (1), R¹ represents a hydrogen atom, an alkyl group having from 6 to 30 carbon atoms (which may have a substituent), an alkenyl group having from 6 to 30 carbon atoms (which may have a substituent), an alkynyl group having from 6 to 30 carbon atoms (which may have a substituent), an aryl group having from 6 to 30 carbon atoms (which may have a substituent) or a hetero ring group having from 6 to 30 carbon atoms (which may have a substituent). Example of the substituent includes a halogen atom, an aryl group, a heterocyclic group, an alkoxyl group, an aryloxy group, an alkylthio group, an arylthio group, an acyl group, a hydroxyl group, an acyloxy group, an amino group, an alkoxycarbonyl group, an acylamino group, an oxycarbonyl group, a carbamoyl group, a sulfonyl group, a sulfamoyl group, a sulfonamide group, a sulfolyl group, a carboxyl group, etc.

R¹ is preferably an alkyl group having from 8 to 24 carbon atoms, an alkenyl group having from 8 to 24 carbon atoms or an alkynyl group having from 8 to 24 carbon atoms, most preferably a linear alkyl group having from 10 to 24 carbon atoms or a linear alkenyl group having from 10 to 24 carbon atoms.

L in formula (1) represents a single bond or a di- or more valent linking group. In the case where L is a linking group, the linking group is preferably one selected from the following units, or one formed by combining any of these units.

Unit: —O—, —CO—, —N(—R²)— (where R² represents an alkyl group having from 1 to 5 carbon atoms), —CH═CH—, —SO₂—.

L in formula (1) is preferably a single bond or has an ester group-derived linking group (—COO—, —OCO—) or an amide group-derived linking group (—CON(R²)—, —N(R²)CO—) as the partial structure thereof.

L may further have a substituent; and not specifically defined, the substituent may be any one selected from those described above for the substituent that R¹ may have. Of those, preferred is —OH.

Preferably, L concretely has the following structure. In the following, p, q and r each indicate an integer of from 1 to 40, preferably from 1 to 20, more preferably from 1 to 10, even more preferably from 1 to 6.

—(CH₂)ₚ—CO—O—(CH₂)_{q}—O—;

—(CH₂)ₚ—CO—O—(CH₂)_{q}—(CH(OH))—(CH₂)ᵣ—O—.

Preferred examples of the organic acid of formula (1) for use in the invention are given below.

### <<Fatty Acid>>

Myristic acid, palmitic acid, stearic acid, oleic acid, linolic acid, linolenic acid, recinoleic acid, undecanoic acid, valeric acid.

### <<Alkylsulfuric Acid>>

Myristylsulfuric acid, cetylsulfuric acid, oleylsulfuric acid.

### <<Alkylbenzenesulfonic Acid>>

Dodecylbenzenesulfonic acid, pentadecylbenzenesulfonic acid.

### <<Alkylnaphthalenesulfonic Acid>>

Sesquibutylnaphthalenesulfonic acid, diisobutylnaphthalenesulfonic acid.

### <<Dialkylsulfosuccinic Acid>>

Dioctylsulfosuccinic acid, dihexylsulfosuccinic acid, dicyclohexylsulfosuccinic acid, diamylsulfosuccinic acid, ditridecylsulfosuccinic acid.

<<Polycarboxylic Acid, and Partial Derivative of Polycarboxylic acid>>

The organic acid of formula (1) for use in the invention is preferably a polycarboxylic acid or a partial derivative of a polycarboxylic acid, and more preferably a partial derivative of a polycarboxylic acid.

The polycarboxylic acid, and the polycarboxylic acid for the partial derivative of a polycarboxylic acid are not specifically defined, for which, for example, preferred are succinic acid, citric acid, tartaric acid, diacetyltartaric acid, malic acid, adipic acid.

In the case where the polycarboxylic acid is not derivative, the polycarboxylic acid is especially preferably citric acid.

The partial derivative of a polycarboxylic acid means an organic acid in which at least one polycarboxylic acid moiety is an unsubstituted carboxyl group and the other carboxyl groups are substituted. Preferably, the other carboxyl group forms an ester bond with an alcohol. Above all, the organic acid of formula (1) for use in the invention preferably has one polyalcohol molecule bonding to one polycarboxylic acid molecule and has at least one, polycarboxylic acid-derived unsubstituted carboxyl group.

The polycarboxylic acid for the partial derivative of a polycarboxylic acid is not specifically defined, for which, for example, preferred are succinic acid, citric acid, tartaric acid, diacetyltartaric acid, malic acid, adipic acid.

The polyalcohol for the partial derivative of a polycarboxylic acid includes adonitol, arabitol, ethylene glycol, diethylene glycol, triethylene glycol, tetraethylene glycol, 1,2-propanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, glycerin, etc.

The fatty acid for the partial derivative of a polycarboxylic acid is not specifically defined, for which is preferred a saturated or unsaturated fatty acid having from 8 to 22 carbon atoms. Concretely mentioned are caprylic acid, capric acid, lauric acid, myristic acid, palmitic acid, stearic acid, behenic acid, oleic acid, etc.

Especially preferably, the partial derivative of a polycarboxylic acid is a carboxyl group-having organic acid monoglyceride having one fatty acid molecule and one polycarboxylic acid molecule bonding to one glycerin molecule.

The carboxyl group-having organic acid monoglyceride for use in the production method of the invention is described in detail hereinunder.

The carboxyl group-having organic acid monoglyceride usable in the invention may be obtained by reacting a polyorganic acid anhydride and a fatty acid monoglyceride generally according to the method described in JP-A 4-218597 and Japanese Patent No. 3823524.

The reaction is attained generally in the absence of a solvent, and for example, the reaction of succinic acid and a fatty acid monoglyceride having 18 carbon atoms maybe attained at a temperature of around 120° C. and may be completed within about 90 minutes. Thus obtained, the organic acid monoglyceride is generally a mixture containing an organic acid, unreacted monoglyceride and diglyceride and other oligomers. In the invention, the mixture may be used directly as it is

For increasing the purity of the carboxyl group-having organic acid monoglyceride, the carboxyl group-having organic acid monoglyceride may be isolated from the mixture through distillation or the like. The carboxyl group-having organic acid monoglyceride having a high purity is commercially available as a distilled monoglyceride, which may be used in the invention. Commercial products of the carboxyl group-having organic acid monoglyceride include, for example, Riken Vitamin's Poem B-30 (glycerinsuccinic acid fatty acid ester), Poem K-37V (glycerincitric acid oleic acid ester), Kao's Step SS (succinic acid monoglyceride in which stearic acid/palmitic acid monoglyceride bonds to succinic acid), etc.

### (2) Rth Controlling Agent:

In the production method of the invention, preferably, the dope contains an Rth controlling agent that regulates the thickness-direction retardation Rth of the formed film from the viewpoint of regulating the Rth expressibility of the film to at least 80 nm.

As the Rth controlling agent, usable is a non-phosphate ester compound.

The polymer additive is preferably a phosphate compound or a non-phosphate polyester compound from the viewpoint of reducing the haze of the formed film.

Preferably, the film of the invention contains a non-phosphate ester compound as the Rth controlling agent. Containing such a non-phosphate ester compound, the film of the invention hardly whitens.

In this description, the “non-phosphate ester compound” means “a compound having an ester bond, in which the acid providing the ester bond is a compound except phosphoric acid”. In other words, the “non-phosphate ester compound” means a compound that is an ester not containing phosphoric acid.

The non-phosphate ester compound may be a low-molecular compound, or may be a polymer compound. The non-phosphate ester compound that is a polymer may be hereinafter referred to as a non-phosphate ester polymer.

As the non-phosphate ester compound serving as an Rth controlling agent, widely employable herein are polymer additives and low-molecular additives known as additives for cellulose acylate films.

The high molecular weight additive for use in the film of the invention as the Rth controlling agent of the non-phosphate ester compound is a compound having repetitive units therein, preferably having a number-average molecular weight of from 700 to 100000. The high molecular weight additive serves to promote the solvent vaporization speed and to reduce the residual solvent amount in a solution casting process. Further, the high molecular weight additive added to the film of the invention is effective from the viewpoint of reforming the film of, for example, enhancing the mechanical properties of the film, imparting flexibility and water absorption resistance to the film and reducing the moisture permeability of the film.

As the high molecular weight additive of the non-phosphate ester compound, those shown in JP-A 2009-263619 can be preferably used.

The high molecular weight additive for use in the invention as the Rth controlling agent of the non-phosphate ester compound more preferably has a number-average molecular weight from 700 to 8000, further preferably from 700 to 5000, particularly preferably 1000 to 5000.

Description will be made in detail of the high molecular weight additives used in the invention as the Rth controlling agent of the non-phosphate ester compound with reference to the specific examples. However, the high molecular weight additives used in the invention as the Rth controlling agent of the non-phosphate ester compound are not limited thereto.

The polymer additive of the non-phosphate ester compound includes polyester polymers (aliphatic polyester polymers, aromatic polyester polymers, etc.), and copolymers of a polyester ingredient and any other ingredient. Preferred are aliphatic polyester polymers, aromatic polyester polymers, copolymers of a polyester polymer (aliphatic polyester polymer, aromatic polyester polymer, etc.) and an acrylic polymer, and copolymers of a polyester polymer (aliphatic polyester polymer, aromatic polyester polymer, etc.) and a styrenic polymer; and more preferred are polyester compounds having an aromatic ring moiety as at least one copolymerization ingredient.

The aliphatic polyester-type polymers is one produced by reaction of a mixture of an aliphatic dicarboxylic acid having from 2 to 20 carbon atoms, and a diol selected from the group consisting of aliphatic diols having from 2 to 12 carbon atoms and alkyl ether diols having from 4 to 20 carbon atoms. Both ends of the reaction product may be as such, or may be blocked by further reaction with monocarboxylic acids, monoalcohols or phenols. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 20 carbon atoms, or an aromatic dicarboxylic acid having from 8 to 20 carbon atoms.

The aliphatic dicarboxylic acids having from 2 to 20 carbon atoms preferably used in the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

More preferred aliphatic dicarboxylic acids in these are malonic acid, succinic acid, maleic acid, fumaric acid, glutaric acid, adipic acid, azelaic acid, 1,4-cyclohexanedicarboxylic acid. Particularly preferred aliphatic dicarboxylic acids are succinic acid, glutaric acid and adipic acid.

The diol used for the high molecular weight agent are selected, for example, from aliphatic diols having from 2 to 20 carbon atoms and alkyl ether diols having from 4 to 20 carbon atoms.

Examples of the aliphatic diol having from 2 to 20 carbon atoms include an alkyldiol and an alicyclic diol. For example, an ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol(3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as combined mixture.

Specific examples of preferred aliphatic diols include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, 1,4-cyclohexanedimethanol.

Specific examples of preferred alkyl ether diols having from 4 to 20 carbon atoms are polytetramethylene ether glycol, polyethylene ether glycol, polypropylene ether glycol, and combinations of these. The average degree of polymerization is not limited in particular, and it is preferably from 2 to 20, more preferably from 2 to 10, further preferably from 2 to 5, especially preferably from 2 to 4. As these examples, Carbowax resin, Pluronics resin and Niax resin are commercially available as typically useful polyether glycols.

In the invention, especially preferred is a high molecular weight agent of which the terminal is blocked with an alkyl group or an aromatic group. The terminal protection with a hydrophobic functional group is effective against aging at high temperature and high humidity, by which the hydrolysis of the ester group is retarded.

Preferably, the high molecular weight agent is protected with a monoalcohol residue or a monocarboxylic acid residue in order that both ends of the compound having a positive birefringence are not a carboxylic acid or a hydroxyl group.

In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol and benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid. One or more of these may be used either singly or as combined.

The high molecular weight agent may be easily produced according to any of a thermal melt condensation method of polyesterification or interesterification of the above-mentioned dicarboxylic acid and diol and/or monocarboxylic acid or monoalcohol for terminal blocking, or according to an interfacial condensation method of an acid chloride of those acids and a glycol in an ordinary manner. The compounds having a positive birefringence are described in detail in Koichi Murai's “Additives, Their Theory and Application” (by Miyuki Publishing, first original edition published on Mar. 1, 1973). The materials described in JP-A 05-155809, 05-155810, 05-197073, 2006-259494, 07-330670, 2006-342227, 2007-003679 are also usable herein.

The aromatic polyester-type polymers are those produced by copolymerization of the polyester polymer and a monomer having an aromatic ring. The monomer having an aromatic ring is preferably at least one monomer selected from an aromatic dicarboxylic acid having from 8 to 20 carbon atoms and an aromatic diol having from 6 to 20 carbon atoms.

The aromatic dicarboxylic acids having from 8 to 20 carbon atoms include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid, 2,6-naphthalene dicarboxylic acid, etc. More preferred aromatic dicarboxylic acids in these are phthalic acid, terephthalic acid, isophthalic acid.

Specific examples of aromatic diols having from 6 to 20 carbon atoms, not limited, include Bisphenol A, 1,2-hydroxybenzene, 1,3-hydroxybenzene, 1,4-hydroxybenzene, 1,4-dimethylolbenzene, and preferably include bisphenol A, 1,4-hydroxybenzene and 1,4-dimethylolbenzene.

For the aromatic polyester polymer, combined is the above-mentioned polyester and at least one of aromatic dicarboxylic acids and aromatic diols, in which the combination mode is not specifically defined. Different types of the ingredients may be combined in any desired mode. In the invention, especially preferred is the polymer additive terminated with an alkyl group or an aromatic group, as described above. For the termination, employable is the above-mentioned method.

As the Rth controlling agent except the above-mentioned non-phosphate ester compound, for example, herein widely employable are phosphate ester compounds and other compounds than ester compounds that are known as additives for cellulose acylate films.

The polymer Rth depressor maybe selected from phosphate polyester polymers, styrenic polymers and acrylic polymers, and their copolymers, and preferred are acrylic polymers and styrenic polymers. Preferably, the Rth depressor contains at least one polymer having a negative intrinsic birefringence such as a styrenic polymer and an acrylic polymer.

As a low molecular weight Rth reducing agent which is not a non-phosphate ester compound, following additives are preferably used. These additives maybe solid or oily, or that is, they are not specifically defined in point of their melting point and boiling point thereof. For example, for the additive, UV absorbents at 20 degrees Celsius or lower and at 20 degrees Celsius or higher may be mixed, or degradation preventive agent may also be mixed in the same manner. IR absorbent dyes are described in, for example, JP-A 2001-194522. The time at which the additive is added may be in any stage in the step of dope preparation; however, the additive may be added in the final stage of the dope preparation step. Not specifically defined, the amount of the material to be added may be any one capable expressing the function thereof.

The low molecular weight Rth depressor that is a compound except non-phosphate esters is not specifically defined, and its details are described in JP-A 2007-272177, paragraphs [0066] to [0085].

The compounds of formula (1) described in JP-A 2007-272177, paragraphs [0066] to [0085] may be produced according to the following method.

The compounds of formula (1) in the patent reference may be obtained through condensation of a sulfonyl chloride derivative and an amine derivative.

The compounds of formula (2) in JP-A 2007-272177 can be obtained through dehydrating condensation of a carboxylic acid and an amine using a condensing agent (for example, dicyclohexylcarbodiimide (DCC) or the like), or through substitution reaction between a carboxylic acid chloride derivative and an amine derivative.

The Rth depressor includes acrylic polymers and styrenic polymers, and low molecular weight compounds of formulae (3) to (7) in JP-A 2007-272177. Of those, preferred are acrylic polymers and styrenic polymers; and more preferred are acrylic polymers.

The Rth controlling agent may be added to the film in a ratio of from 0.01 to 30% by mass of cellulose acetate.

When the amount to be added is at most 30% by mass, the miscibility of the additive with the cellulose resin is high and the formed film may be prevented from whitening. In the case where two or more different types of Rth controlling agent s are used as combined, preferably, the total amount thereof falls within the above range.

More preferably, the Rth controlling agent is added in a ratio of from 10 to 30% by mass of cellulose acetate from the viewpoint of further reducing the haze of the formed film, even more preferably from 15 to 30% by mass.

### (3) Inorganic Fine Particles

The film of the invention preferably includes inorganic fine particles in an outmost layer of at least one side.

An inorganic fine particles (matting agent) are preferably added in the film of the invention. Examples of fine particles for use in the invention include silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate and calcium phosphate. Inorganic fine particles containing silicon are preferred because turbidity becomes low, and silicon dioxide is particularly preferred. Preferable inorganic fine particles of silicon dioxide have a primary average particle size of 20 nm or less, and an apparent specific gravity of 70 g/l or more. Those having the primary average particle size as small as from 5 to 30 nm are more preferred because they can lower haze of the film. As for an apparent specific gravity, from 10 to 100 g/l is preferred, and from 30 to 80 g/l is more preferred.

In the case where the film of the invention is a laminate of two layers, the inorganic fine particles are contained in an outermost layer of at least one side. And, in the case where the film of the invention is a laminate of three or more layers, the inorganic fine particles are preferably contained in the outermost layers of both sides.

These inorganic fine particles form secondary particles usually having an average particle size of from 0.1 to 3.0 μm and these fine particles exist as aggregates of the primary particles to form irregularity of from 0.1 to 3.0 μm on the surface of the film. As for the secondary average particle size, from 0.2 μm to 1.5 μm is preferred, from 0.4 μm to 1.2 μm is more preferred, and from 0.6 μm to 1.1 μm is most preferred. The primary and secondary particle sizes are defined as the diameter of a circle circumscribing the particle, which is obtained by observing particles in the film under a scanning electron microscope. The average particle size is defined as an averaged value of the size of particles obtained by observing 200 particles at different positions.

As fine particles of silicon dioxide, marketed productions can be used, including, for example, AEROSIL R972, R972V, R974, R812, 200, 200V, 300, R202, OX50 and TT600 (all of them are manufactured by NIPPON AEROSIL CO., LTD.) etc. As fine particles of zirconium oxide, for example, those available in the market under trade names of AEROSIL R976 and R811 (manufactured by NIPPON AEROSIL CO., LTD.) can be used.

Among these, AEROSIL R972V is particularly preferred, from the viewpoint of aggregating property at the time of preparing the dispersion of inorganic fine particles.

In order to obtain a film having particles with a small secondary average particle size in the invention, several procedures are conceived upon preparing a dispersion liquid of fine particles. For example, there is such method that a dispersion liquid of fine particles is prepared in advance by stirring and mixing a solvent and fine particles, then the dispersion liquid of fine particles is added to a small amount of cellulose acylate solution having been prepared separately to be stirred and dissolved, which is further mixed with a main cellulose acylate dope liquid. This method is a preferable preparation method in that it results in a good dispersibility of silicon dioxide fine particles, hardly allowing the silicon dioxide fine particles to aggregate again. As an alternative, there is also such method that a solvent is added with a small amount of cellulose acylate to be stirred and dissolved, then fine particles are added to the solution to be dispersed by a dispersing apparatus to form a fine particles addition liquid, and the fine particles addition liquid is sufficiently mixed with a dope liquid by an in-line mixer. However, the invention is not restricted to these methods. When silicon dioxide fine particles are dispersed by mixing them with a solvent or the like, concentration of silicon dioxide is preferably from 5 to 30% by mass, more preferably from 10 to 25% by mass, most preferably from 15 to 20% by mass. A higher dispersion concentration results in a lower liquid turbidity relative to the addition amount and better haze and aggregates, and thus is preferred.

As for usable solvents, as lower alcohols, preferable examples include methyl alcohol, ethyl alcohol, propyl alcohol, isopropyl alcohol and butyl alcohol. Solvents other than lower alcohols are not particularly restricted, but use of a solvent that is used at a film-forming step of cellulose acylate is preferred.

### (4) Plasticizer

Various compounds known as a plasticizer for a cellulose acylate may be used as a plasticizer in the invention. As the plasticizer, usable are phosphates or carboxylates. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methoxyacetyl ricinoleate, dibutyl sebacate, and various trimellitates. Preferred for use herein are phthalate plasticizers (DMP, DEP, DBP, DOP, DPP, DEHP). More preferred are DEP and DPP.

### (5) Re Enhancer

Although the film of the invention shows desired in-plane retardation regardless that an Re enhancer is added or not, the film may contain an Re enhancer. When the Re enhancer is added to the film, the film shows a high expressed Re after stretching by a relatively low stretching ratio. The retardation enhancer for use in the invention includes rod-shaped compounds, discotic compounds and compounds showing Re enhancing capability selected from the above non-phosphate ester compound. Of the rod-shaped or discotic compounds, those having at least two aromatic groups are preferred for use as the Re enhancer in the invention.

Two or more different types of Re enhancers may be used, as combined.

Preferably, the Re enhancer has a maximum absorption in a wavelength range of from 250 to 400 nm, and preferably, it does not have substantial absorption in a visible light region.

As the Re enhancer, for example, employable here are the compounds described in JP-A 2004-50516 and 2007-86748, to which, however, the invention is not limited.

As the discotic compound, for example, preferred for use herein are the compounds described in EP 0911656A2, the triazine compounds described in JP-A 2003-34455, and the triphenylene compounds described in JP-A 2008-150592, paragraphs [0097] to [0108].

The discotic compounds may be produced according to known methods, for example, according to the method described in JP-A 2003-344655 or the method described in JP-A 2005-134884.

Also preferred for use in the invention are rod-shaped compounds having a linear molecular structure, in addition to the above-mentioned discotic compounds; and for example, preferred for use herein are the rod-shaped compounds described in JP-A 2008-150592, paragraphs [0110] to [0127].

Two kinds or more of the rod-shaped compounds, which have a maximum absorption wavelength (λmax) of less than 250 nm in an ultraviolet spectrum of the solution, may be used simultaneously.

A rod-shaped compound can be synthesized according to methods described in references. As the references, Mol. Cryst. Liq. Cryst., vol. 53, p 229 (1979); Mol. Cryst. Liq. Cryst., vol. 89, p 93 (1982); Mol. Cryst. Liq. Cryst., vol. 145, p 111 (1987); Mol. Cryst. Liq. Cryst., vol. 170, p 43 (1989); Journal of the American Chemical Society, vol. 113, p 1349 (1991); Journal of the American Chemical Society, vol. 118, p 5346 (1996); Journal of the American Chemical Society, vol. 92, p 1582 (1970); Journal of Organic Chemistry, vol. 40, p 420 (1975); and Tetrahedron, vol. 48, No. 16, p 3437 (1992) can be mentioned.

The Re enhancer is preferably added in an amount of from 0.2 to 10% by mass, more preferably added in an amount of from 0.5 to 5% by mass, particularly preferably added in an amount of from 1 to 4% by mass, relative to the amount of the cellulose acetate.

Furthermore, the Re enhancer and Rth controlling agent are preferably used together appropriately from the viewpoint of controlling the Re and Rth of the film to fall within the preferable range and producing the cellulose acetate film having a low haze.

### (Preparing Dope)

The dope may be prepared according to an ordinary method in the producing method of the invention. In one general method, the solution is processed at a temperature not lower than 0° C. (room temperature or high temperature). For preparing the dope, employable is a method and an apparatus for dope preparation according to an ordinary solvent casting method. The solution may be prepared by stirring a cellulose acylate and an organic solvent at room temperature (from 0 to 40° C.). A high-concentration solution may be stirred under pressure and under heat. Concretely, a cellulose acylate and an organic solvent are put-into a pressure chamber, then closed and stirred therein and under heat at a temperature within a range between the boiling point of the solvent at room temperature and the boiling point under the pressure. The heating temperature is generally 40° C. or higher, preferably from 60 to 200° C., more preferably from 80 to 110° C.

The ingredients may be put into the chamber (a tank, etc.) after roughly premixed. They may be put into the chamber one after another. The chamber must be so planned that the contents therein could be stirred. An inert gas such as nitrogen gas or the like may be introduced into the chamber to pressurize it. The solvent may be heated, and vapor pressure of it may be utilized to pressurize the chamber. Alternatively, after the chamber is closed, the ingredients may be introduced thereinto under pressure.

Preferably, the contents in the chamber are heated in an external heating mode. For example, a jacket type heating unit maybe used. A plate heater maybe disposed outside the chamber, and a liquid may be circulated through the pipeline disposed in the heater to thereby heat the entire chamber.

Also preferably, a stirring blade may be disposed inside the chamber, with which the contents may be stirred. The stirring blade preferably has a length that reaches near the wall of the chamber. At the tip of the stirring blade, a scraper is preferably provided for renewing the liquid film formed on the wall of the chamber.

The chamber may be equipped with various meters such as a pressure gauge, a thermometer, etc. In the chamber, the ingredients are dissolved in the solvent. Thus prepared, the dope is taken out of the chamber after cooled, or after taken out of it, the dope preferably be cooled with a heat exchanger or the like.

The solution may also be prepared according to a cooling dissolution method. According to the cooling dissolution method, a cellulose acylate maybe dissolved even in an organic solvent in which it can be hardly dissolved in an ordinary dissolution method. For the solvent in which a cellulose acylate can be dissolved in an ordinary dissolution method, the cooling dissolution method is advantageous in that a uniform solution can be prepared rapidly.

In the cooling dissolution method, first, a cellulose acylate is gradually added to an organic solvent at room temperature with stirring. The amount of the cellulose acylate is so controlled that the resulting mixture can contain it in an amount of from 10 to 90% by mass. The amount of the cellulose ester is more preferably from 10 to 30% by mass.

Next, the mixture is cooled to from −100 to −10° C. (preferably from −80 to −10° C., more preferably from −50 to −20° C., most preferably from −50 to −30° C.). The cooling may be attained, for example, in a dry ice/methanol bath (−75° C.) or in a cooled diethylene glycol solution (−30 to −20° C.). Thus cooled, the mixture of cellulose acylate and organic solvent is solidified.

The cooling speed is preferably at least 4° C./min, more preferably at least 8° C./min, most preferably at least 12° C./min. The cooling speed is preferably higher, but its theoretical uppermost limit is 10000° C./sec, the technical uppermost limit is 1000° C./sec, and the practicable uppermost limit is 100° C./sec. The cooling speed is a value computed by dividing the difference between the temperature at the start of the cooling and the final cooling temperature by the time taken from the start of the cooling to the arrival to the final cooling temperature.

Further, this is heated at from 0 to 200° C. (preferably from 0 to 150° C., more preferably from 0 to 120° C., most preferably from 0 to 50° C.), and the cellulose acylate is thereby dissolved in the organic solvent. For the heating, the solid may be left at room temperature, or may be heated in a hot bath. The heating speed is preferably at least 4° C./min, more preferably at least 8° C./min, most preferably at least 12° C./min. The heating speed is preferably higher; but its theoretical uppermost limit is 10000° C./sec, the technical uppermost limit is 1000° C./sec, and the practicable uppermost limit is 100° C./sec. The heating speed is a value computed by dividing the difference between the temperature at the start of the heating and the final heating temperature by the time taken from the start of the heating to the arrival to the final heating temperature.

As in the above, a uniform solution can be obtained. When the dissolution is insufficient, then the cooling and heating operation may be repeated. As to whether or not the dissolution is satisfactory may be determined merely by visually observing the outward appearance of the solution.

In the cooling dissolution method, preferably used is a closed container for the purpose of preventing the mixture from being contaminated with water from the dew formed in cooling. In the cooling and heating operation, preferably, the chamber is made under pressure in cooling and is made under reduced pressure in heating, to thereby shorten the dissolution time. For pressurizing and depressurizing the chamber, preferably used is a pressure chamber.

A 20% by mass solution prepared by dissolving a cellulose acylate (having a degree of total acetyl substitution of 60.9%, and having a viscosity-average degree of polymerization of 299) in methyl acetate according to the cooling dissolution method has a pseudo-phase transition point between a sol state and a gel state at around 33° C., when analyzed through differential scanning calorimetry (DSC), and at a temperature lower than the point, the solution is in the form of a uniform gel. Accordingly, the solution must be stored at a temperature not lower than the pseudo-phase transition temperature, preferably at around a temperature of the gel-phase transition temperature plus 10° C. or so. However, the pseudo-phase transition temperature differs, depending on the degree of total acetyl substitution and the viscosity-average degree of polymerization of the cellulose acylate and on the solution concentration and the organic solvent used.

In the invention, preferably, cellulose acetate is previously dried in a silo, and then mixed with the above-mentioned solvent to prepare a dope. More preferably, the additives to be added to the dope are previously dried in a silo, and then mixed with the solvent and cellulose acetate to prepare a dope.

### <Casting and Peeling>

The producing method of the invention is characterized in comprising casting a dope containing a cellulose acetate and a solvent on a support to prepare a dope film, wherein the total substitution degree of the cellulose acetate is from 2.0 to 2.7 (hereinafter referred to as a casting step); and peeling away the dope film from the support (hereinafter referred to as a peeling step). That is, in the invention, a cellulose acetate film can be produced from thus prepared dope with solvent casting method.

Furthermore, in the invention, the support is preferably a moving strip-shaped support.

Furthermore, in the producing method of the invention, the residual solvent amount is preferably controlled to be at most 100% at the time when the dope film is peeled away. In the region where the dope film is peeled away from the support, the support is preferably kept in contact with a cooling unit having a surface temperature of 10° C. or lower, on the side thereof opposite to the side from which the dope film is peeled away.

Particularly, in the second embodiment of the producing method of the invention, the residual solvent amount is preferably controlled to be at most 100% at the time when the dope film is peeled away from a moving strip-shaped support. In the region where the dope film is peeled away from the support, the support is preferably kept in contact with a cooling unit having a surface temperature of 10° C. or lower, on the side thereof opposite to the side from which the dope film is peeled away.

Hereinafter described are the casting step and the peeling step in the producing method of the invention with reference to preferred embodiments thereof.

Equipments for use in the casting step of the method for producing the cellulose acetate film of the invention in which the acyl substitution degree of the cellulose acetate is low may be the same as the solution casting method and the solution casting machines for use in the conventional producing method of cellulose triacetate film. In the producing method of the invention, for example, the machines described in JP-A 2004-359379 are preferably used.

The casting and drying method in solvent casting is described in U.S. Pat. Nos. 2,336,310, 2,367,603, 2,492,078, 2,492,977, 2,492,978, 2,607,704, 2,739,069, 2,739,070, British Patents 640731, 736892, JP-B 45-4554, 49-5614, JP-A 60-176834, 60-203430, 62-115035.

Furthermore, the cellulose acylate film producing methods described in JP-A 2000-301555, 2000-301558, H07-032391, H03-193316, H05-086212, S62-037113, H02-276607, S55-014201, H02-111511 and H02-208650 can be used in the invention.

Hereinafter, more concretely described are preferred embodiments of the casting step and the peeling step in the producing method of the invention.

The dope (cellulose acetate solution) prepared in a dissolving machine (kettle) is preferably once stored in a storing kettle and finalized by removing the bubbles contained in the dope.

In the producing method in the invention, the dope is cast on an running belt like shaped support. The dope is supplied to a pressure-type die from the dope discharge port through, for example, a pressure-type quantitative gear pump capable of feeding a constant amount of solution with high precision by the number of rotations, and uniformly cast on the running belt like shaped support in the casting part from the mouth ring (slit) of the pressure-type die.

Not specifically defined, the moving strip-shaped support is preferably a band-like or belt-like one, more preferably an endless band or belt. Using such an endless support makes it possible to endlessly move the dope. The strip-shaped support may be moved in any mode, but is preferably an endless belt hung and running between at least two rolls (drums).

Not also specifically defined in point of the material thereof, the strip-shaped support is preferably made of a metal, more preferably SUS (for example, SUS 316).

Preferably, the specific heat of the strip-shaped support is from 0.1 to 1.0 J/(m³·K).

Preferably, the width of the strip-shaped support is from 1 to 3 m, more preferably from 1.5 to 3 m, even more preferably about 2 m. About 2 m as referred to herein means to fall within a range 2 m±30 cm.

Preferably, the length of the strip-shaped support (so-called band length) is from 80 to 100 m.

Preferably, the surface roughness (Ra value) of the strip-shaped support is at most 0.01 μm. Also preferably, the surface of the strip-shaped support is mirror-finished. Mirror-finishing means that polishing is repeated to smooth the band surface. Further, the band surface is polished for so-called super-mirror finish thereby to have a higher level thickness precision in the cross direction.

Preferably, the thickness of the strip-shaped support is from 1.5 to 2 mm.

The strip-shaped support is kept in contact with a cooling unit on the side thereof opposite to the side from which the formed film is to be released. Not specifically defined in point of the shape thereof, the cooling unit may be a cooling plate or a cooling curved surface unit. Especially preferred is a cylindrical cooling unit. Preferably, the cooling unit is a driving roll or a driven roller, and the strip-shaped support is wound around any of these rolls. Preferably, the diameter of the roll is from 2 to 3 m. In the case where the apparatus has plural rolls, preferably, at least one is a driving roll that positively rotates the strip-shaped support by a motor. The other rolls around which the strip-shaped support is wound may be driving rolls or driven rolls that are driven by the driving roll to run.

The moving speed of the strip-shaped support that is driven by the driving roll to run is preferably from 15 to 80 m/sec.

In the production method of the invention, preferably, the dope is uniformly cast on the strip-shaped support, and then the dope film is peeled away from the support under a specifically controlled condition. In the production method of the invention, the dope-peeling region (hereinafter this may be referred to as release point) is not specifically defined. Preferably, the residual solvent amount in peeling the dope film is controlled to be at most 100%, and in the region where the dope film is peeled away from the support, a cooling unit having a surface temperature of not higher than 10° C. is kept in contact with the support on the side of the support opposite to the side thereof from which the dope film is peeled away. In particular, in the second aspect of the invention, the residual solvent amount is controlled to be at most 100% at the time when the dope film is peeled away, and in the region where the dope film is peeled away from the support, the support is kept in contact with a cooling unit having a surface temperature of not higher than 10° C., on the side thereof opposite to the side from which the dope film is peeled away. In that manner, preferably, the solvent is evaporated away on the strip-like support and then the wet dope film (this may be referred to as web) is peeled away from the strip-shaped support, from the viewpoint of improving the peeling property of the film.

In one concrete embodiment where the strip-shaped support is an endless belt, preferably, the point at which the running film has traveled by nearly one circle or less is set as the release point.

Especially in the second aspect of the production method of the invention, the residual solvent amount in peeling the dope film is preferably controlled to be at most 55%. In the second aspect of the production method of the invention, more preferably, the surface temperature of the cooling unit is not higher than −5° C.

Regarding the method of controlling the residual solvent amount in peeling the dope film to be at most 100%, for example, JP-B 5-17894 has a description. There may be mentioned a method of casting the dope onto the strip-shaped support and then drying it through to air for at least 2 seconds. Also mentioned is a method of controlling the surface temperature of the strip-like support to be from 10° C. to 40° C. in the region where the residual solvent amount is controlled until the support reaches around the release point.

The residual solvent amount may be represented by the following formula:

Residual Solvent Amount (% by mass)={(M−N)/N}×100

wherein M means the mass of the web at an undefined point, and N means the mass of the web having the mass M, dried at 110° C. for 3 hours.

More preferably, the residual solvent amount in peeling the dope film is controlled to be at most 50% by mass, even more preferably at most 45% by mass, still more preferably less than 45% by mass. Also preferably, the residual solvent amount in peeling the dope film is at least 30% by mass from the viewpoint of more effective film Rth expression.

In the production method of the invention, preferably, the cooling unit having a surface temperature of not higher than 10° C. is kept in contact with the support on the side thereof opposite to the dope film release side in the region where the dope film is peeled from the support. Preferably, the cooling unit serves also as a roll that rotates the moving strip-shaped support. Regarding the method of controlling the surface temperature of the cooling unit, for example, the cooling unit may be cooled to have a surface temperature of not higher than 10° C. (the uppermost temperature is preferably 5° C. or lower, more preferably 0° C. or lower, even more preferably −5° C. or lower), using a brain chiller that comprises an antifreeze liquid. The surface temperature of the roll nearest to the peeling region is preferably from −25° C. to 5° C., more preferably from −25° C. to 0° C., even more preferably from −20° C. to −5° C.

By controlling the surface temperature of the cooling unit to fall within the temperature range and by controlling the residual solvent amount in the dope to fall within the above-mentioned range, the dope can gel at the surface temperature of the strip-shaped support on which the dope is cast, and the peeling property of the cellulose acetate web having a low degree of acyl substitution can be noticeably improved.

On the other hand, in the region where the dope film is peeled away from the support, the surface temperature of the support on the side thereof from which the dope film is peeled away may be good to be not always 10° C. or lower, but is preferably 10° C. or lower, and the preferred range of the temperature is the same as the preferred range of the surface temperature of the cooling unit.

Especially in the first aspect of the invention, preferably, the solid concentration in the casting dope is controlled to be from 15% to 25% from the viewpoint of the film surface condition after dried, more preferably from 16% to 23%, even more preferably from 17% to 22%.

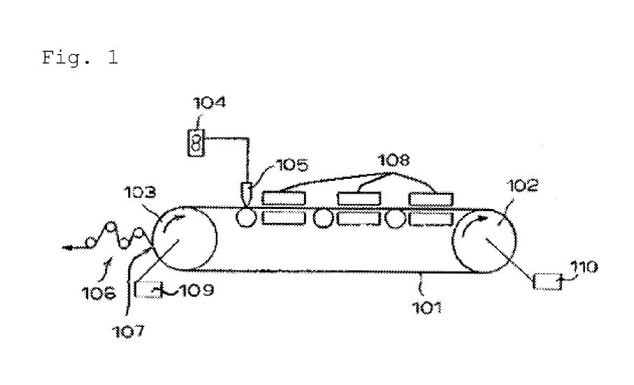

An embodiment of the band casting apparatus preferred for use for the production method of the invention is shown in FIG. 1.

FIG. 1 shows an example of a cellulose acetate film continuous production apparatus using a single metal-made endless belt 101 of which the surface is polished for super-mirror finish to have a high-level thickness precision in the cross direction of the belt. In the continuous film production apparatus, preferably, the metal-made endless belt 101 is formed of, for example, stainless steel, and has a thickness of about 1.5 mm and a width of about 3 m, the belt speed is from 2 to 100 m/min, and the product film thickness is at most 10 μm. Depending on the type of the apparatus, a thicker film or sheet may also be produced. The metal-made endless belt 101 is hung to run between the driven roll 102 on the film-transferring side and the driving roll 103 on the material resin feeding side, and is positively rotated by the driving roll 103.

In the continuous film production apparatus illustrated in the drawing, a cellulose acetate dope is fed onto the upper surface of the belt on the side of the driving roll 103 at a constant rate from the high-precision gear pump 104, and via the specially-planned T-die 105, this is extruded to a given width, and while transferred onto the side of the driven roll on the belt 101, this is heated in three stages by the residual solvent amount controlling units 108. Subsequently, via the belt-turning part on the side of the driven roll 102, the film is transferred toward the side of the driving roll 103 while rotated by the endless belt 101 and while held on the lower surface of the belt 101, and then the dope film is peeled away from the endless belt 101 in the peeling region 107, and via the group of take-up rolls 106 arranged outside the driving roll 103, the film is then wound up in the winding unit (not shown) after peeled from the endless belt 101. In this, the driving roll 103 is provided with a cooling device 109, and in the peeling region 107, the surface temperature of the cooling unit, or that is, the driving roll 103, is controlled to fall within a specific range. More preferably, the operating unit of a belt-meandering preventing device 110 is arranged on the side of the driven roll 102.

A method of drying the web that is dried on a drum or belt and is peeled away from it is described. The web peeled away at the peeling position just before one lap of the drum or the belt is conveyed according to a method where the web is led to pass alternately through rolls disposed like a houndstooth check, or according to a method where the peeled web is conveyed in a non-contact mode while both sides of the web are held by clips or the like. The drying may be attained according to a method where the wind at a predetermined temperature is given to both surfaces of the web (film) being conveyed, or according to a method of using a heating means such as microwaves, etc. Rapid drying may damage the surface smoothness of the formed film. Therefore, in the initial stage of drying, the web is dried at a temperature at which the solvent does not bubble, and after having gone on in some degree, the drying may be preferably attained at a high temperature. In the drying step after peeled away from the support, the film tends to shrink in the machine direction or in the cross direction owing to solvent evaporation. The shrinkage may be larger in drying at a higher temperature. Preferably, the shrinkage is inhibited as much as possible for bettering the surface condition of the film to be formed. From this viewpoint, for example, preferred is a method (tenter method) where the entire drying step or a part of the drying step is carried out with both sides of the web held with clips or pins so as to keep the width of the web, as in JP-A 62-46625. The drying temperature in the drying step is preferably from 100 to 145° C. The drying temperature, the drying wind speed and the drying time may vary depending on the solvent used, and are therefore suitably selected in accordance with the type and the combination of the solvent to be used. The web can be dried by high temperature wind which varies its temperature sequentially to evaporate the residual solvent.

### <Stretching>

The producing method of the invention preferably includes stretching the web (film) peeled away from the support at the temperature satisfying the following inequality (1) from the viewpoint of increasing optical expression and restraining the film whitening.

Te−30° C.≦Stretching temperature≦Te+30° C., (1)

Te=T[tan δ]−ΔTm (1) (1′)

ΔTm=Tm(0)−Tm(x) (1″)

In the above inequalities, T[tan δ] represents the temperature at which tan δ shows a peak in measurement of the dynamic viscoelasticity tan δ of cellulose acetate having a residual solvent amount of 0%; Tm(0) represents the crystal melting temperature of the cellulose acetate having a residual solvent amount of 0%; and Tm(x) represents the crytal melting temperature of the cellulose acetate having a residual solvent amount of x %.

The residual solvent amount may be represented by the following formula:

Residual Solvent Amount (% by mass)={(M−N)/N}×100

wherein M means the mass of the web at an undefined point, and N means the mass of the web having the mass M, dried at 110° C. for 3 hours. When the residual solvent amount in the web is too much, then the web could not enjoy the effect of its stretching; but when too small, stretching the web is extremely difficult, and the web may be broken. More preferably, the residual solvent amount in the web is from 10 to 50% by mass, even more preferably from 12 to 30% by mass. In the case where the draw ratio in stretching is too small, the film could not have a sufficient retardation; but when too large, the film could not be stretched and would be broken.

In the invention, the film produced according to a solution casting method and having a residual solvent amount falling within a specific range can be stretched, not heated at a high temperature; however, preferably, the film is stretched while dried, as the processing process may be shortened. However, when the temperature of the web is too high, then the plasticizer may evaporate away, and therefore, the temperature range is preferably from room temperature (15° C.) to 145° C. A method of stretching the film in two directions perpendicular to each other is effective for controlling the film refractivity, Nx, Ny and Nz to fall within the range of the invention. For example, when the film is stretched in the casting direction and when the shrinkage in the cross direction is too large, then the value Nz may increase too much. In this case, the problem may be solved by reducing the cross shrinkage of the film and by stretching the film in the cross direction. In the case where the film is stretched in the cross direction, the film may have a refractivity distribution in the cross direction. This often occurs, for example, when a tenter method is employed for film stretching. This is a phenomenon to be caused by the generation of the shrinking force in the center part of the film while the edges of the film are kept fixed, and this may be considered as a so-called bowing phenomenon. Also in this case, the bowing phenomenon can be prevented by stretching the film in the casting direction, whereby the retardation distribution in the cross direction can be reduced. Further, by stretching the film in two directions perpendicular to each other, the film thickness fluctuation may be reduced. When the film thickness fluctuation of a cellulose acylate film is too large, then the distribution fluctuation thereof may also be large. The film thickness fluctuation of the cellulose acylate film is preferably within a range of ±3%, more preferably within a range of ±1%. For the above-mentioned objects, the method of stretching the film in two directions perpendicular to each other is effective, and the draw ratio in stretching in two directions perpendicular to each other is preferably from 1.2 to 2.0 times in one direction and from 0.7 to 1.0 times in the other direction. The mode of stretching the film by from 1.2 to 2.0 times in one direction and by from 0.7 to 1.0 times in the other direction means that the distance between the clips and the pins supporting the film is made to be from 0.7 to 1.0 times the distance therebetween before the stretching.

In general, in the case where the film is stretched in the cross direction by from 1.2 to 2.0 times, using a biaxial stretching tenter, a shrinking force acts on the perpendicular direction thereof, or that is, on the machine direction of the film.

Accordingly, when the film is stretched while a force is kept applied only in one direction, then the width of the film in the other direction perpendicular to that one direction may shrink. The method means that the shrinking degree is controlled without control of the width of the film, or that is, this means that the distance between the clips or the pins for width control is defined to be from 0.7 to 1.0 times the distance therebetween before stretching. In this case, a force of shrinking the film in the machine direction acts on the film owing to the stretching in the cross direction. The distance kept between the clips or the pins in the machine direction makes it possible to prevent any unnecessary tension from being given to the film in the machine direction thereof. The method of stretching the web is not specifically defined. For example, there are mentioned a method of providing plural rolls each running at a different peripheral speed and stretching the film in the machine direction based on the peripheral speed difference between the rolls, a method of holding both sides of the web with clips or pins and expanding the distance between the clips or pins in the machine direction to thereby stretch the film in the machine direction, or expanding the distance therebetween in the cross direction to thereby stretch the film in the cross direction, and a method of expanding the distance both in the machine direction and in the cross direction to thereby stretch film in both the machine and cross directions. Needless-to-say, these methods may be combined. In the so-called tenter method, preferably, the clip parts are driven according to a linear driving system, by which the film may be smoothly stretched with little risk of breaking, etc.

The film draw ratio (which may be referred to as draw ratio) in the stretching step is preferably from 1.2 to 2.0 times, more preferably from 1.3 to 1.5 times.

In the case where the residual solvent amount in the film being stretched is 0% by mass relative to the cellulose acetate contained in the dope, then Te=T[tan δ]; and in that case, the film is stretched at T[tan δ]−30° C. stretching temperature≦T[tan δ]+30° C.

T[tan δ] is a temperature at which tan δ shows a peak in measurement of the dynamic viscoelasticity tan δ of cellulose acetate having a residual solvent amount of 0% with Vibron, and this is intrinsic to film. Vibron to be used in measuring the dynamic viscoelasticity is not specifically defined. For example, usable here is DVA200, IT Measurement and Control's trade name.

Tm(0) means the crystal melting temperature of cellulose acetate having a residual solvent amount of 0%. Tm(x) means the crystal melting temperature of cellulose acetate having a residual solvent amount of x %. In general, regarding the relationship between the residual solvent amount in the peeled film and the crystal melting temperature Tm of the film, Tm lowers with the increase in the residual solvent amount. For measuring the crystal melting temperature, employable is any known method of using DSC; and for example, the temperature may be measured according to the method described in Disclosure Bulletin 2001-1745, pp. 11-12.

In this, T[tan δ] could not be measured in a film that contains a residual solvent. However, by defining the stretching temperature to fall within the range of formula (1) in the invention, the dimensional change of the obtained film, as aged in a wet heat environment, can be significantly reduced even when the film is stretched while it still contains a residual solvent therein. Not adhering to any theory, stretching at a stretching temperature corrected according to the formulae (1) and (1′) with taking the matter into consideration that the residual solvent has an influence by ΔTm, as obtained according to the above-mentioned formula (1″), on the stretching temperature, surprisingly reduces the above-mentioned dimensional change even when the residual solvent-containing film is stretched.

For example, the methods for stretching in the direction perpendicular to the film conveying direction are described in JP-A 62-115035, 04-152125, 04-284211, 04-298310, and 11-48271. For example, to stretch a film in the film conveying direction (longitudinal direction), the film can be drawn by adjusting the speed of a film conveying rollers such that the film winding rate is faster than the film peeling rate. To stretch a film in the direction perpendicular to the film conveying direction, the film can also be drawn by conveying the film while holding the film toward the width direction using a tenter and gradually widening the width of the tenter. After drying the film, the film can be drawn by using a drawing machine. Preferably, the film is uniaxially drawn by using a long drawing machine.

In the case where the cellulose acetate film is used as a protective film of a polarizing element, for the purpose of inhibiting light leakage in viewing a polarizer from an inclined direction, it is necessary to dispose a transmission axis of the polarizing element in parallel to an in-plane slow axis of the cellulose acetate film. Since the transmission axis of a polarizing element in a rolled film state to be continuously produced is generally parallel to the width direction of the rolled film, in order to continuously stick the polarizing element in a rolled film state and a protective film composed of the cellulose acetate film in a rolled film state, it is necessary that the in-plane slow axis of the protective film in a rolled film state is parallel to the width direction of the film. Accordingly, it is preferable that the film is more likely stretched in the width direction. Also, the stretching treatment may be achieved on the way of the fabrication step, and a raw film having been fabricated and wound up may be subjected to a stretching treatment. In the producing method of the invention, the film is preferably stretched during the film fabrication process because the film is stretched in a state of containing a residual solvent.

### <Heat Treatment>

Preferably, the film production method of the invention includes the heat treatment step after the drying step. The heat treatment in the heat treatment step may be attained after the drying step, and it may be attained just after the stretching/drying step, or after the drying step, the film may be once wound up according to the method to be mentioned below, and may be heat-treated in the next heat treatment step provided separately. Preferably in the invention, after the drying step, the film is once cooled to room temperature to 100° C. or lower, and then it is processed in the heat treatment step separately provided. This is advantageous in that a film having more excellent thermal dimensional stability can be obtained. For the same reason, preferably, the film just before the heat treatment step is dried to such a degree that the residual solvent amount in the film could be less than 2% by mass, more preferably less than 0.4% by mass.

Though not clear, the reason why the shrinkage of the film could be reduced through the treatment may be because, in the film stretched in the stretching step has a large residual stress in the stretching direction, and the residual stress may be removed by the heat treatment and therefore the shrinking force in the region below the heat treatment temperature may be thereby reduced.

The heat treatment may be attained according to method where air at a predetermined temperature is given to the film being conveyed, or according to a method of using a heating means such as microwaves, etc.

Preferably, the heat treatment is at a temperature of from 150 to 200° C., more preferably from 160 to 180° C. Also preferably, the heat treatment is for from 1 to 20 minutes, more preferably from 5 to 10 minutes.

When the heat treatment temperature is higher than 200° C. and when the film is heated at such a temperature for a long period of time, this it may be problematic in that the plasticizer in the film may much evaporate away and scatter.

In the heat treatment step, the film shrinks in the machine direction or in the cross direction. Preferably, during the heat treatment, the shrinkage is prevented as much as possible in order that the produced film could have a good surface smoothness. For this, preferred is a method where both sides of the film are held by clips or pins so as to keep the width of the film as such (tenter method). Also preferably, the film is heat-treated while stretched in the cross direction and in the machine direction by from 0.9 times to 1.5 times each.

### <Winding>

With clipping both edges thereof, preferably, the obtained web is conveyed with a tenter and dried, and subsequently conveyed by the roll group of the drying unit to finish the drying, and thereafter the dried film is wound up with a winding machine to a predetermined length. The combination of the tenter and the drying unit with the roll group may be changed depending on the intended object.

As a winder which is used in manufacturing the obtained film, a generally used winder may be used; and the film can be wound up by a winding method, for example, a constant-tension method, a constant-torque method, a taper tension method and a program tension control method in which an internal stress is constant. The optical film roll thus produced in the manner as above is preferably such that the slow axis direction of the film is within a range of ±2 degrees relative to the winding direction (longitudinal direction of the film), more preferably within a range of ÷1 degree. Also preferably, the slow axis direction of the film is within ±2 degrees relative to the perpendicular direction to the winding direction (cross direction of the film), more preferably within a range of ±1 degree. Even more preferably, the slow axis direction of the film is within a range of ±0.1 degrees relative to the winding direction (longitudinal direction of the film). Also preferably, it is within a range of ±0.1 degrees relative to the cross direction of the film.

The film thickness can be adjusted by adjusting the concentration of solids to be contained in the dope, the slit gap of a nozzle of the die, the extrusion pressure from the die, the speed of the metal support or the like so as to obtain a desired thickness.

The thus obtained film preferably wound up in a length of from 100 to 10,000 m, more preferably from 500 to 7,000 m, and further preferably from 1,000 to 6,000 m per roll. It is preferable that the width of the film is from 0.5 to 5.0 m, more preferably from 1.0 to 3.0 m, and further preferably from 1.0 to 2.5 m. In winding-up, it is preferable to apply knurling to at least one end; the width of knurling is preferably from 3 mm to 50 mm, and more preferably from 5 mm to 30 mm; and the height of knurling is preferably from 0.5 to 500 μm, and more preferably from 1 to 200 μm. This maybe single-sided pressing or double-sided pressing.

Generally, in large screen displays, reduction in contrast and tint in inclination direction are significant. Accordingly, the film of the invention is particularly suitable for large screen liquid crystal displays. When the film is used for a large screen liquid crystal display as an optically compensational film, it is preferred to form a film having a width of 1470 mm or more. Further, the film of the invention includes not only a piece film cut to the size with which the film can be directly assembled in liquid crystal display, but also the film which is produced in a long shape by consecutive production to be wound in the form of a roll. With the latter, the film is held and transported as it is, and is used by cutting to a desirable size when actually embedded in a liquid crystal display and adhered to the polarizing element, or the like. Further, with the latter, the film directly adheres to a polarizing element, or the like which is produced in a long shape and includes a polyvinyl alcohol film, and then is used by cutting to a desirable size when actually embedded in liquid crystal display. The wound roll-shaped film includes a film wound in a roll length of 2500 m or more.

In the solution casting film formation method used for a functional protective film of electronic displays, in addition to the solution casting film formation apparatus, a coating apparatus is added in many cases so as to apply surface treatment to the film, such as subbing layer, antistatic layer, antihalation layer and protective layer.

### [Cellulose Acetate Film]

### (Retardation)

The film of the invention is produced by the producing method for a cellulose acetate film of the invention, and is characterized in that the retardation in the thickness direction Rth at the wave length of 590 nm of the film is preferably 80 nm or more. Rth of the film is preferably from 80 to 300 nm, more particularly preferably from 80 to 150 nm. As Rth of the film is controlled to be within the range, a retardation film for VA mode crystal-liquid cell which can inhibit color shift is produced.

The in-plane retardation Re at the wave length of 590 nm of the film of the invention is preferably from 30 to 100 nm.

Re of the film is preferably from 35 to 85 nm, more particularly preferably from 40 to 60 nm.

Re(λ) and Rth(λ) represent, herein, a retardation in the in-plane and a retardation in the thickness direction, respectively, at a wavelength of λ in the description. In the description, λ is 590 nm unless otherwise indicated. Re(λ) is measured by applying light having a wavelength of λ nm to a film in the normal direction of the film, using KOBRA 21ADH or WR (by Oji Scientific Instruments). The selectivity of the measurement wavelength λ nm may be conducted by a manual exchange of a wavelength-filter, a program conversion of a measurement wavelength value or the like.

When a film to be analyze by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (A) and (B):

$$Re ( θ ) = [ nx - \frac{( ny \times nz )}{( \sqrt{\begin{matrix}{\{ ny ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} )} ] \times \frac{d}{cos \{ {sin}^{- 1} ( \frac{sin ( - θ )}{nx} ) \}} \qquad Formula ( A )$$

wherein Re(θ) represents a retardation value in the direction inclined by an angle θ from the normal direction.

wherein nx represents a refractive index in the in-plane slow axis direction; ny represents a refractive index in the in-plane direction perpendicular to nx; and nz represents a refractive index in the direction perpendicular to nx and ny in the formula (A). And “d” is a thickness of the sample. Formula (B):

Rth={(nx+ny)/2−nz}×d

When the film to be analyzed is not expressed by a monoaxial or biaxial index ellipsoid, or that is, when the film does not have an optical axis, then Rth(λ) of the film may be calculated as follows.

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below: cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

### (Thickness of Film)

The thickness of the film of invention may be set suitably according to the kind of polarizer to be applied and others, and it is preferably from 30 to 60 μm, more preferably from 35 to 55 μm. When the thickness of the film is at most 60 μm, it is preferable to reducing the producing cost.

### (Haze)

The cellulose acylate film of the present invention has a total haze of 1.0% or less, more preferably 0.8% or less, particularly preferably less than 0.5%, more particularly preferably 0.3% or less.

### [Polarizer]

The polarizer of the invention includes a polarizing element and at least one sheet of the cellulose acetate film of the invention.

The cellulose acetate film of the invention is preferably for use in a protective film in a polarizer. A polarizer is constructed by laminating a protective film on at least one surface of a polarizing element. The polarizing element may be any conventional one. For example, this is prepared by processing a hydrophilic polymer film such as a polyvinyl alcohol film with a dichroic dye such as iodine. Not specifically defined, the cellulose acetate film may be stuck to the polarizing element in any desired manner, for which, for example, an adhesive of an aqueous solution of a water-soluble polymer may be used. Preferably, the water-soluble polymer adhesive is an aqueous solution of completely-saponified polyvinyl alcohol.

Preferred embodiments of the constitution of the polarizer of the invention include a constitution of polarizer-protective film/polarizing element/polarizer-protective film/liquid crystal cell/cellulose acetate film of the invention/polarizing element/polarizer-protective film; or a constitution of polarizer-protective film/polarizing element/cellulose acetate film of the invention/liquid crystal cell/cellulose acetate film of the invention/polarizing element/polarizer-protective film. In particular, the polarizer of the invention is favorably stuck to a TN-mode, VA-mode or OCB-mode liquid crystal cell, thereby constructing liquid crystal displays excellent in viewing angle and visibility with little coloration. In particular, the polarizer comprising the cellulose acetate film of the invention is excellent in the low degradation under high-temperature high-humidity condition, and therefore can maintain stable performance for a long period of time under high-temperature high-humidity condition.

Embodiments of the polarizer of the invention include not only sheet-like polarizers cut into a size capable of being directly incorporated in liquid crystal display devices but also rolled polarizers produced as a film and wound up into a roll in continuous production (for example, having a rolled film length of 2500 m or more, or 3900 m or more). For use in large-panel liquid crystal display devices, the width of the polarizer is preferably at least 1470 mm as mentioned above.

The concrete constitution of the polarizer of the invention is not specifically defined, for which any known constitution is employable. For example, the constitution illustrated in FIG. 6 in JP-A 2008-262161 is employable here.

### [Liquid Crystal Display Device]

The liquid crystal display device of the invention comprises the cellulose acetate film of the invention.

The film of the invention is applicable to the liquid crystal display device having the polarizer of the invention.

The liquid crystal display device of the invention is preferably an IPS, OCB or VA-mode liquid crystal display device that comprises a liquid crystal cell and a pair of polarizers arranged on both sides of the liquid crystal cell, in which at least one polarizer is the polarizer of the invention.

The concrete constitution of the liquid crystal display device of the invention is not specifically defined, for which any known constitution is employable. The constitution illustrated in FIG. 2 in JP-A 2008-262161 is also preferably employed here.

### EXAMPLES

The characteristics of the invention are described more concretely with reference to the following Examples. In the following Examples, the material used, its amount and the ratio, the details of the, treatment and the treatment process may be suitably modified or changed. Accordingly, the invention should not be limitatively interpreted by the Examples mentioned below.

In this invention, the measurement was performed by the following measuring methods.

### (Peeling Aptitude Test)

In Examples and Comparative Examples, the fluctuation width of the peeling point in peeling the cast film as a wet film from the support (peeling before stretching) was measured, and the peeling aptitude of the film was evaluated.
⊚: Peeling point fluctuation width, 0 mm with no fluctuation (extremely light).
◯: Peeling point fluctuation width, from more than 0 mm to 2 mm with some fluctuation (light).
▴: Peeling point fluctuation width, fluctuation of from more than 2 mm to 5 mm (relatively heavy).
×: Peeling point fluctuation width, fluctuation of from more than 5 mm to 10 mm (heavy).
××: Peeling point fluctuation width, fluctuation of more than 10 mm (extremely heavy).

According to the above evaluation, the peeling aptitude was evaluated, and the obtained results are shown in the following Table 3 to Table 5. The samples in Comparative Examples 1, 3 to 6 and Comparative Examples 101, 103 to 106 were not tested for the peeling aptitude evaluation.

### (Re, Rth)

Re and Rth of the film were analyzed with KOBRA 21ADH (by Oji Scientific Instruments) at a wavelength of 590 nm using the above mentioned method. The results are shown in Table 3 to Table 5 below.

### (Haze)

The measurement of total haze is made on a film sample having a size of 40 mm×80 mm according to the invention at 25° C. and relative humidity 60% according to JIS K-6714 using a Type HGM-2DP haze meter (produced by Suga Test Instruments Co., Ltd.). The results are shown in Table 3 to Table 5 below.

### Examples 1 to 53 and 101 to 141, Comparative Examples 1 to 7 and 101 to 106

### Film Formation of Cellulose Acetate Film

### (1) Preparation of Cellulose Acetate Dope

Cellulose acetate was prepared, of which the degree of substitution is shown in the following Table 3 to Table 5. Concretely, a catalyst, sulfuric acid (in an amount of 7.8 parts by mass relative to 100 parts by mass of cellulose) was added to cellulose, and then carboxylic acid to give the acyl group was added thereto, and the cellulose was acylated at 40° C. In this and after the acylation, the amount of the sulfuric acid used as a catalyst, the amount of water and the aging time were changed to thereby change and control the total degree of substitution and the degree of 6-position substitution. After the acylation, the product was aged at 40° C. The low molecular weight component was removed from the cellulose acylate by washing with acetone.

### Cellulose Acetate Solution:

Cellulose acetate shown in the following Table 3 to Table 5, dichloro methane and alcohol shown in the following Table 3 to Table 5 were put into a mixing tank and stirred to dissolve the ingredients. After heated at 90° C. for about 10 minutes, this was filtered through a paper filter having a mean pore size of 34 μm and a sintered metal filter having a mean pore size of 10 μm. Then inorganic fine particles and each additive shown in the following Table 3 to Table 5 were added to the solution to prepare a cellulose acetate solution. The inorganic fine particles were prepared by a disperser. Each additive was stirred to dissolve in the solution with heating. The composition of the cellulose acetate dope for Example 1 is shown below.

Cellulose Acylate Solution for Example 1 (for example)

| | |
|---|---|
| Cellulose acylate (degree of acetyl substitution is 2.10) | 100.0 mas. pts. |
| Compound B (Rth controlling agent) | 19.0 mas. pts. |
| Inorganic fine particles (Aerosil R972) | 0.2 mas. pts. |
| Methylene chloride | 365.5 mas. pts. |
| Ethanol | 54.6 mas. pts. |

### (Additives)

Added amount of the Rth controlling agent and Re controlling agent (the additive 2) is shown by mass % relative to the amount of the cellulose acetate in the following Table 3 to Table 5. In Table 4 and Table 5, AA represents:

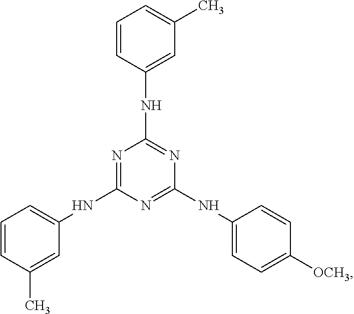

AB represents:

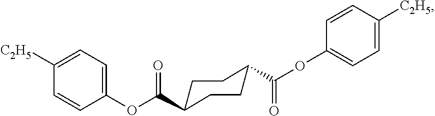

and AC represents:

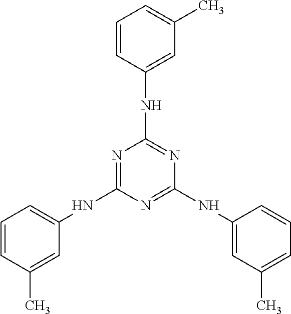

Additive A is the compound D-1 shown in JP-A 2009-222994. The structure of additive A is as follows:

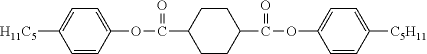

The compositions of Additives B to H are shown in following Table 1. In the following Table 1, EG means ethylene glycol, PG means propylene glycol, BG means butylene glycol, TPA means terephthalic acid, PA means phthalic acid, AA means adipic acid, and SA means succinic acid.

Added amount of the additives is shown by mass % relative to the amount of the plastic resin contained in the dope.

TABLE 1

| | Glycol unit | | | | | Dicarboxylic acid unit | | | | | |
|---|---|---|---|---|---|---|---|---|---|---|---|
| | | | | | Averaged | | | | | Averaged | |
| | Ratio of blocking | | | | number | | | | | number | |
| | both terminal | EG | PG | BG | of carbon | TPA | PA | AA | SA | of carbon | Molecular |
| | hydroxyls (%) | (mol %) | (mol %) | (mol %) | atoms | (mol %) | (mol %) | (mol %) | (mol %) | atoms | weight |
| Additive B | 100 | 50 | 50 | 0 | 2.5 | 55 | 0 | 5 | 40 | 6.3 | 800 |
| Additive C | 100 | 100 | 0 | 0 | 2 | 45 | 5 | 20 | 30 | 6.4 | 840 |
| Additive D | 0 | 50 | 50 | 0 | 2.5 | 55 | 0 | 0 | 45 | 6.2 | 690 |
| Additive E | 100 | 50 | 50 | 0 | 2.5 | 50 | 0 | 0 | 50 | 6 | 670 |
| Additive F | 0 | 25 | 75 | 0 | 2.75 | 45 | 5 | 0 | 50 | 6 | 790 |
| Additive G | 0 | 100 | 0 | 0 | 2 | 0 | 0 | 60 | 40 | 5.2 | 1000 |
| Additive H | 100 | 75 | 25 | 0 | 2.75 | 10 | 10 | 0 | 80 | 4.8 | 800 |

In Examples 11 to 13 and Examples 115 to 117, ethyl citrate (monoester 40%, diester 40%, triester 10%) was mixed as a release promoter HK with cellulose acetate in an amount of 300 ppm to prepare a dope for film formation. In Examples 14 to 23 and Examples 118 to 127, the release promoter shown in the following Table 2 was mixed in the amount indicated in the following Table 3 to Table 5 to prepare a dope for film formation. The final blend ratio of the cellulose acetate, the solvent and the additive is as shown in the following Table 3 to Table 5.

The cellulose acetate and the additive used as the material for the dope were previously dried using a silo (by Nara machinery) at 120° C. for 2 hours.

The solid concentration in the dope was measured, and shown in the following Table 3 to Table 5.

TABLE 2

| Release | |
|---|---|
| promoter | Organic acid |
| HK | Citric ester |
| HK2 | Poem K-37V |
| | (produced by Riken Vitamin Co., ltd.) |
| HK3 | STEP SS |
| | (produced by Kao Corporation) |
| HK4 | Oleic acid |
| | (produced by Tokyo Chemical Industry Co., Ltd.) |
| HK5 | Undecanoic acid |
| | (produced by Tokyo Chemical Industry Co., Ltd.) |
| HK6 | Citric acid |
| | (produced by Tokyo Chemical Industry Co., Ltd.) |
| HK7 | valeric acid |
| | (produced by Tokyo Chemical Industry Co., Ltd.) |

### (2) Casting Film Formation, Peeling:

The dope was cast, using the band caster having the constitution shown in FIG. 1. The band was formed of SUS 316, and the band width was about 2 m. The band was an endless belt, and the band length was about 80 m. The surface roughness, Ra value of the band was 0.01 μm, and the band thickness was from about 1.5 to 2 mm. The band was polished for ultra-mirror finish. The endless metal belt of the band caster was hung to run between two rolls, and its diameter was about 2.5 m. Of the rolls, the roll on the side on which the dope film is peeled away was equipped with a cooling device. The cooling device was so designed that it could chill the roll by the brain chiller, and the roll could serve as a cooling unit capable of controlling its surface temperature to be as in the following Table 3 to Table 5. The moving speed of the endless metal belt was 40 m/sec.

Using a residual solvent amount controlling device capable of suitably controlling the charge air temperature to be from 80° C. to 130° C. on the band (the discharge air temperature was from 75° C. to 120° C.), the dope film was dried so that the residual solvent amount therein could be as in the following Table 3 to Table 5 in the peeling region, and the dope film was then peeled away from the band.

In Table 3 to Table 5, “36, then dried to 0” in Example 52 and Example 104 means that the film was peeled at the time when the residual solvent amount was 36%, and then, not stretched (or that is, not via the stretching zone), the film was dried at 120° C. for 30 minutes, and thereafter the dried film was stretched. Also in Example 53, the dried film was stretched, like in Example 52.

### (3) Stretching:

The obtained web (film) was peeled away from the band, clipped, and when the residual solvent amount therein was from 30 to 5% relative to the mass of the entire film, the film was stretched under the condition of edge-fixed monoaxial stretching at the stretching temperature shown in the following Table 3 to Table 5, and at a draw ratio of 1.3 times in the direction perpendicular to the film traveling direction (that is, in the cross direction) using a tenter.

Subsequently, the film was unclipped, and dried at 130° C. for 20 minutes. In this, the casting film thickness was so controlled that the thickness of the stretched film could be as in Table 3 to Table 5 (film thickness unit: μm). According to the method, cellulose acetate films of Examples and Comparative Examples having the properties as shown in Table 3 to Table 5 were produced, and for the purpose of evaluating the production aptitude thereof, the film in the form of a roll having a roll width of 1280 mm and a roll length of 2600 mm was produced to be at least 24 rolls. One of those 24 rolls thus produced continuously was cut at regular intervals of 100 m to be samples each having a length of 1 m (having a width of 1280 mm), and the samples were tested and analyzed.

TABLE 3

| | Cellulose acylate dope | | | | | | |
|---|---|---|---|---|---|---|---|
| | Solvent | | | | | | |
| | | | | | | average | Total acyl |
| | | | | | Amount of | carbon | degree of |
| | | Composition | | Composition | alcohol | numbers of | cellulose |
| | Main solvent | [mass %] | Other solvent | [mass %] | [mass %] | alcohol | acetate |
| Comp. Ex. 1 | Methylene chloride | 80 | Ethanol | 20 | 20 | 2 | 1.90 |
| Ex. 1 | Methylene chloride | 80 | Ethanol | 20 | 20 | 2 | 2.10 |
| Ex. 2 | Methylene chloride | 80 | Ethanol | 20 | 20 | 2 | 2.30 |
| Ex. 3 | Methylene chloride | 80 | Ethanol | 20 | 20 | 2 | 2.42 |
| Ex. 4 | Methylene chloride | 80 | Ethanol | 20 | 20 | 2 | 2.55 |
| Ex. 5 | Methylene chloride | 80 | Ethanol | 20 | 20 | 2 | 2.65 |
| Comp. Ex. 2 | Methylene chloride | 80 | Ethanol | 20 | 20 | 2 | 2.75 |
| Comp. Ex. 3 | Methylene chloride | 80 | Ethanol/methanol | 18/2 | 20 | 1.9 | 1.90 |
| Ex. 6 | Methylene chloride | 80 | Ethanol/methanol | 18/2 | 20 | 1.9 | 2.10 |
| Ex. 7 | Methylene chloride | 80 | Ethanol/methanol | 18/2 | 20 | 1.9 | 2.30 |
| Ex. 8 | Methylene chloride | 80 | Ethanol/methanol | 18/2 | 20 | 1.9 | 2.42 |
| Ex. 9 | Methylene chloride | 80 | Ethanol/methanol | 18/2 | 20 | 1.9 | 2.55 |
| Ex. 10 | Methylene chloride | 80 | Ethanol/methanol | 18/2 | 20 | 1.9 | 2.65 |
| Comp. Ex. 4 | Methylene chloride | 80 | Ethanol/methanol | 18/2 | 20 | 1.9 | 2.75 |
| Ex. 11 | Methylene chloride | 80 | Ethanol | 20 | 20 | 2 | 2.30 |
| Ex. 12 | Methylene chloride | 80 | Ethanol | 20 | 20 | 2 | 2.42 |
| Ex. 13 | Methylene chloride | 80 | Ethanol | 20 | 20 | 2 | 2.50 |
| Ex. 14 | Methylene chloride | 87 | Ethanol | 13 | 13 | 2 | 2.42 |
| Ex. 15 | Methylene chloride | 87 | Ethanol | 13 | 13 | 2 | 2.42 |
| Ex. 16 | Methylene chloride | 87 | Ethanol | 13 | 13 | 2 | 2.42 |
| Ex. 17 | Methylene chloride | 87 | Ethanol | 13 | 13 | 2 | 2.42 |
| Ex. 18 | Methylene chloride | 87 | Ethanol | 13 | 13 | 2 | 2.42 |
| Ex. 19 | Methylene chloride | 87 | Ethanol | 13 | 13 | 2 | 2.42 |
| Ex. 20 | Methylene chloride | 87 | Ethanol | 13 | 13 | 2 | 2.42 |
| Ex. 21 | Methylene chloride | 87 | Ethanol | 13 | 13 | 2 | 2.42 |
| Ex. 22 | Methylene chloride | 87 | Ethanol | 13 | 13 | 2 | 2.42 |
| Ex. 23 | Methylene chloride | 87 | Ethanol | 13 | 13 | 2 | 2.42 |
| Comp. Ex. 5 | Methylene chloride | 80 | Methanol | 20 | 20 | 1 | 2.42 |
| Ex. 24 | Methylene chloride | 80 | n-Buthanol | 20 | 20 | 4 | 2.42 |
| Ex. 25 | Methylene chloride | 80 | iso-Buthanol | 20 | 20 | 4 | 2.42 |
| Ex. 26 | Methylene chloride | 80 | Ethanol/ | 5/15 | 5 | 2 | 2.42 |
| | | | ethylene glycol | | | | |
| Comp. Ex. 6 | Methylene chloride | 80 | n-Hexanol | 20 | 20 | 6 | 2.42 |

| | Cellulose acylate dope | | | | | | |
|---|---|---|---|---|---|---|---|
| | Additives | | | | | | Solids |
| | | | Rth | | | | concentration |
| | Releasing | Amount | controlling | Amount | Additives | Amount | in dope |
| | promoter | [ppm] | agent | [mass %] | 2 | [mass %] | [mass %] |
| Comp. Ex. 1 | Nothing | | B | 19 | | | 21 |
| Ex. 1 | Nothing | | B | 19 | | | 21 |
| Ex. 2 | Nothing | | B | 19 | | | 21 |
| Ex. 3 | Nothing | | B | 19 | | | 21 |
| Ex. 4 | Nothing | | B | 19 | | | 21 |
| Ex. 5 | Nothing | | B | 19 | | | 21 |
| Comp. Ex. 2 | Nothing | | B | 19 | | | 21 |
| Comp. Ex. 3 | Nothing | | B | 19 | | | 21 |
| Ex. 6 | Nothing | | B | 19 | | | 21 |
| Ex. 7 | Nothing | | B | 19 | | | 21 |
| Ex. 8 | Nothing | | B | 19 | | | 21 |
| Ex. 9 | Nothing | | B | 19 | | | 21 |
| Ex. 10 | Nothing | | B | 19 | | | 21 |
| Comp. Ex. 4 | Nothing | | B | 19 | | | 21 |
| Ex. 11 | HK | 300 | B | 19 | | | 21 |
| Ex. 12 | HK | 300 | B | 19 | | | 21 |
| Ex. 13 | HK | 300 | B | 19 | | | 21 |
| Ex. 14 | HK2 | 20000 | B | 19 | | | 21 |
| Ex. 15 | HK2 | 20000 | B | 17 | | | 21 |
| Ex. 16 | HK2 | 20000 | B | 15 | | | 21 |
| Ex. 17 | HK2 | 2000 | B | 17 | | | 21 |
| Ex. 18 | HK2 | 500 | B | 17 | | | 21 |
| Ex. 19 | HK3 | 20000 | B | 17 | | | 21 |
| Ex. 20 | HK4 | 20000 | B | 17 | | | 21 |
| Ex. 21 | HK5 | 20000 | B | 17 | | | 21 |
| Ex. 22 | HK6 | 20000 | B | 17 | | | 21 |
| Ex. 23 | HK7 | 20000 | B | 17 | | | 21 |
| Comp. Ex. 5 | Nothing | | B | 19 | | | 21 |
| Ex. 24 | Nothing | | B | 19 | | | 21 |
| Ex. 25 | Nothing | | B | 19 | | | 21 |
| Ex. 26 | Nothing | | B | 19 | | | 21 |
| Comp. Ex. 6 | Nothing | | B | 19 | | | 21 |

| | | | | | Film property | | | | | | |
|---|---|---|---|---|---|---|---|---|---|---|---|
| | Condition of film peeling | | | | | | Thickness | | | | |
| | Roll | Residual | Stretching | | Film | | after | | | | |
| | temperature | solvent | temperature | Tm(0) | Te | Peeling | stretching | Re | Rth | haze | Total |
| | [° C.] | [mass %] | [° C.] | [° C.] | [° C.] | aptitude | [μm] | [nm] | [nm] | [%] | evaluation |
| Comp. Ex. 1 | 15 | 36 | 156 | 182 | 146 | X | 58 | 70 | 200 | 0.5 | X |
| Ex. 1 | 15 | 36 | 156 | 182 | 146 | ⊚ | 58 | 62 | 170 | 0.4 | ⊚ |
| Ex. 2 | 15 | 36 | 150 | 176 | 140 | ⊚ | 58 | 56 | 148 | 0.3 | ⊚ |
| Ex. 3 | 15 | 36 | 144 | 170 | 134 | ⊚ | 58 | 50 | 120 | 0.3 | ⊚ |
| Ex. 4 | 15 | 36 | 139 | 165 | 129 | ⊚ | 58 | 45 | 115 | 0.3 | ⊚ |
| Ex. 5 | 15 | 36 | 134 | 160 | 124 | ⊚ | 58 | 42 | 100 | 0.6 | ⊚ |
| Comp. Ex. 2 | 15 | 35 | 133 | 158 | 123 | ⊚ | 58 | 20 | 70 | 0.9 | X |
| Comp. Ex. 3 | 15 | 32 | 160 | 182 | 150 | X | 58 | 69 | 198 | 0.5 | X |
| Ex. 6 | 15 | 32 | 160 | 182 | 150 | ⊚ | 58 | 60 | 168 | 0.4 | ◯ |
| Ex. 7 | 15 | 32 | 154 | 176 | 144 | ⊚ | 58 | 55 | 147 | 0.3 | ⊚ |
| Ex. 8 | 15 | 31 | 149 | 170 | 139 | ⊚ | 58 | 49 | 118 | 0.3 | ⊚ |
| Ex. 9 | 15 | 31 | 144 | 165 | 134 | ⊚ | 58 | 44 | 114 | 0.3 | ⊚ |
| Ex. 10 | 15 | 31 | 139 | 160 | 129 | ⊚ | 58 | 40 | 95 | 0.5 | ◯ |
| Comp. Ex. 4 | 15 | 30 | 138 | 158 | 128 | ⊚ | 58 | 20 | 70 | 0.9 | X |
| Ex. 11 | 15 | 35 | 151 | 176 | 141 | ⊚ | 58 | 55 | 147 | 0.3 | ⊚ |
| Ex. 12 | 15 | 35 | 145 | 170 | 135 | ⊚ | 58 | 49 | 118 | 0.3 | ⊚ |
| Ex. 13 | 15 | 35 | 140 | 165 | 130 | ⊚ | 58 | 44 | 115 | 0.3 | ⊚ |
| Ex. 14 | 15 | 40 | 134 | 172 | 132 | ⊚ | 58 | 50 | 119 | 0.3 | ⊚ |
| Ex. 15 | 15 | 41 | 136 | 175 | 134 | ⊚ | 57 | 50 | 119 | 0.3 | ⊚ |
| Ex. 16 | 15 | 42 | 137 | 177 | 135 | ⊚ | 56 | 50 | 119 | 0.3 | ⊚ |
| Ex. 17 | 15 | 45 | 132 | 175 | 130 | ◯ | 56 | 50 | 119 | 0.3 | ◯ |
| Ex. 18 | 15 | 41 | 136 | 175 | 134 | ▴ | 54 | 50 | 119 | 0.3 | ▴ |
| Ex. 19 | 15 | 41 | 133 | 172 | 131 | ⊚ | 57 | 50 | 119 | 0.3 | ⊚ |
| Ex. 20 | 15 | 40 | 134 | 172 | 132 | ⊚ | 58 | 50 | 119 | 0.3 | ⊚ |
| Ex. 21 | 15 | 41 | 133 | 172 | 131 | ⊚ | 56 | 50 | 119 | 0.3 | ⊚ |
| Ex. 22 | 15 | 42 | 132 | 172 | 130 | ⊚ | 55 | 50 | 119 | 0.3 | ⊚ |
| Ex. 23 | 15 | 41 | 133 | 172 | 131 | ⊚ | 57 | 50 | 119 | 0.3 | ⊚ |
| Comp. Ex. 5 | 15 | 35 | 150 | 175 | 140 | X | 58 | — | — | — | X |
| Ex. 24 | 15 | 35 | 150 | 175 | 140 | ◯ | 58 | 42 | 135 | 0.6 | ◯ |
| Ex. 25 | 15 | 35 | 150 | 175 | 140 | ◯ | 58 | 40 | 125 | 0.7 | ◯ |
| Ex. 26 | 15 | 35 | 150 | 175 | 140 | ◯ | 58 | 42 | 135 | 0.6 | ◯ |
| Comp. Ex. 6 | 15 | 35 | 150 | 175 | 140 | X | 58 | — | — | — | X |

TABLE 4

| | Cellulose acylate dope | | | | | | |
|---|---|---|---|---|---|---|---|
| | Solvent | | | | | | |
| | | | | | | average | Total acyl |
| | | | | | Amount of | carbon | degree of |
| | | Composition | | Composition | alcohol | numbers of | cellulose |
| | Main solvent | [mass %] | Other solvent | [mass %] | [mass %] | alcohol | acetate |
| Comp. Ex. 7 | Methylene chloride | 86 | Ethanol | 14 | 14 | 2 | 2.42 |
| Ex. 27 | Methylene chloride | 84 | Ethanol | 16 | 16 | 2 | 2.42 |
| Ex. 28 | Methylene chloride | 75 | Ethanol | 25 | 25 | 2 | 2.42 |
| Ex. 29 | Methylene chloride | 70 | Ethanol | 30 | 30 | 2 | 2.42 |
| Ex. 30 | Methylene chloride | 80 | Ethanol | 20 | 20 | 2 | 2.42 |
| Ex. 31 | Methylene chloride | 80 | Ethanol | 20 | 20 | 2 | 2.42 |
| Ex. 32 | Methylene chloride | 80 | Ethanol | 20 | 20 | 2 | 2.42 |
| Ex. 33 | Methylene chloride | 80 | Ethanol | 20 | 20 | 2 | 2.42 |
| Ex. 34 | Methylene chloride | 80 | Ethanol | 20 | 20 | 2 | 2.42 |
| Ex. 35 | Methylene chloride | 80 | Ethanol | 20 | 20 | 2 | 2.42 |
| Ex. 36 | Methylene chloride | 80 | Ethanol | 20 | 20 | 2 | 2.42 |
| Ex. 37 | Methylene chloride | 80 | Ethanol | 20 | 20 | 2 | 2.42 |
| Ex. 38 | Methylene chloride | 80 | Ethanol | 20 | 20 | 2 | 2.42 |
| Ex. 39 | Methylene chloride | 80 | Ethanol | 20 | 20 | 2 | 2.42 |
| Ex. 40 | Methylene chloride | 80 | Ethanol | 20 | 20 | 2 | 2.42 |
| Ex. 41 | Methylene chloride | 80 | Ethanol | 20 | 20 | 2 | 2.42 |
| Ex. 42 | Methylene chloride | 80 | Ethanol | 20 | 20 | 2 | 2.42 |
| Ex. 43 | Methylene chloride | 80 | Ethanol | 20 | 20 | 2 | 2.42 |
| Ex. 44 | Methylene chloride | 80 | Ethanol | 20 | 20 | 2 | 2.42 |
| Ex. 45 | Methylene chloride | 80 | Ethanol | 20 | 20 | 2 | 2.42 |
| Ex. 46 | Methylene chloride | 80 | Ethanol | 20 | 20 | 2 | 2.42 |
| Ex. 47 | Methylene chloride | 80 | Ethanol | 20 | 20 | 2 | 2.42 |
| Ex. 48 | Methylene chloride | 80 | Ethanol | 20 | 20 | 2 | 2.42 |
| Ex. 49 | Methylene chloride | 80 | Ethanol | 20 | 20 | 2 | 2.42 |
| Ex. 50 | Methylene chloride | 80 | Ethanol | 20 | 20 | 2 | 2.42 |
| Ex. 51 | Methylene chloride | 80 | Ethanol | 20 | 20 | 2 | 2.42 |
| Ex. 52 | Methylene chloride | 80 | Ethanol | 20 | 20 | 2 | 2.42 |
| Ex. 53 | Methylene chloride | 80 | Ethanol/methanol | 18/2 | 20 | 1.9 | 2.42 |

| | Cellulose acylate dope | | | | | | |
|---|---|---|---|---|---|---|---|
| | Additives | | | | | | Solids |
| | | | Rth | | | | concentration |
| | Releasing | Amount | controlling | Amount | Additives | Amount | in dope |
| | promotor | [ppm] | agent | [mass %] | 2 | [mass %] | [mass %] |
| Comp. Ex. 7 | Nothing | | B | 19 | | | 21 |
| Ex. 27 | Nothing | | B | 19 | | | 21 |
| Ex. 28 | Nothing | | B | 19 | | | 21 |
| Ex. 29 | Nothing | | B | 19 | | | 21 |
| Ex. 30 | Nothing | | B | 19 | | | 21 |
| Ex. 31 | Nothing | | B | 19 | | | 21 |
| Ex. 32 | Nothing | | B | 19 | | | 21 |
| Ex. 33 | Nothing | | B | 19 | | | 21 |
| Ex. 34 | Nothing | | B | 5 | | | 21 |
| Ex. 35 | Nothing | | B | 10 | | | 21 |
| Ex. 36 | Nothing | | B | 15 | | | 21 |
| Ex. 37 | Nothing | | B | 20 | | | 21 |
| Ex. 38 | Nothing | | A | 15 | | | 21 |
| Ex. 39 | Nothing | | C | 15 | | | 21 |
| Ex. 40 | Nothing | | D | 15 | | | 21 |
| Ex. 41 | Nothing | | E | 15 | | | 21 |
| Ex. 42 | Nothing | | F | 15 | AA | 1 | 21 |
| Ex. 43 | Nothing | | G | 15 | AB | 2 | 21 |
| Ex. 44 | Nothing | | H | 15 | AC | 1.5 | 21 |
| Ex. 45 | Nothing | | B | 19 | | | 16 |
| Ex. 46 | Nothing | | B | 19 | | | 18 |
| Ex. 47 | Nothing | | B | 19 | | | 20 |
| Ex. 48 | Nothing | | B | 19 | | | 22 |
| Ex. 49 | Nothing | | B | 19 | | | 21 |
| Ex. 50 | Nothing | | B | 19 | | | 21 |
| Ex. 51 | Nothing | | B | 19 | | | 21 |
| Ex. 52 | Nothing | | B | 19 | | | 21 |
| Ex. 53 | Nothing | | B | 19 | | | 21 |

| | | | | | Film property | | | | | | |
|---|---|---|---|---|---|---|---|---|---|---|---|
| | Condition of film peeling | | | | | | Thickness | | | | |
| | Roll | Residual | Stretching | | Film | | after | | | | |
| | temperature | solvent | temperature | Tm(0) | Te | Peeling | stretching | Re | Rth | haze | Total |
| | [° C.] | [mass %] | [° C.] | [° C.] | [° C.] | aptitude | [μm] | [nm] | [nm] | [%] | evaluation |
| Comp. Ex. 7 | 15 | 30 | 155 | 175 | 145 | X | 58 | — | — | — | X |
| Ex. 27 | 15 | 33 | 151 | 174 | 141 | ◯ | 58 | 45 | 115 | 0.6 | ◯ |
| Ex. 28 | 15 | 40 | 143 | 173 | 133 | ⊚ | 58 | 48 | 119 | 0.6 | ⊚ |
| Ex. 29 | 15 | 45 | 137 | 172 | 127 | ⊚ | 58 | 52 | 122 | 0.6 | ⊚ |
| Ex. 30 | 15 | 35 | 149 | 174 | 139 | ⊚ | 58 | 49 | 118 | 0.6 | ⊚ |
| Ex. 31 | 0 | 35 | 149 | 174 | 139 | ⊚ | 58 | 49 | 118 | 0.6 | ⊚ |
| Ex. 32 | −5 | 35 | 149 | 174 | 139 | ⊚ | 58 | 49 | 118 | 0.2 | ⊚ |
| Ex. 33 | −15 | 35 | 149 | 174 | 139 | ⊚ | 58 | 49 | 118 | 0.2 | ⊚ |
| Ex. 34 | 15 | 35 | 160 | 185 | 150 | ▴ | 58 | 55 | 128 | 0.7 | ▴ |
| Ex. 35 | 15 | 35 | 155 | 180 | 145 | ◯ | 58 | 52 | 122 | 0.6 | ◯ |
| Ex. 36 | 15 | 35 | 151 | 176 | 141 | ⊚ | 58 | 50 | 120 | 0.3 | ⊚ |
| Ex. 37 | 15 | 35 | 145 | 170 | 135 | ⊚ | 58 | 41 | 112 | 0.3 | ⊚ |
| Ex. 38 | 15 | 35 | 152 | 177 | 142 | ⊚ | 58 | 50 | 120 | 0.5 | ⊚ |
| Ex. 39 | 15 | 35 | 155 | 180 | 145 | ⊚ | 58 | 50 | 120 | 0.5 | ⊚ |
| Ex. 40 | 15 | 35 | 151 | 176 | 141 | ⊚ | 58 | 50 | 120 | 0.5 | ⊚ |
| Ex. 41 | 15 | 35 | 152 | 177 | 142 | ⊚ | 58 | 50 | 120 | 0.5 | ⊚ |
| Ex. 42 | 15 | 35 | 150 | 175 | 140 | ⊚ | 58 | 50 | 120 | 0.5 | ⊚ |
| Ex. 43 | 15 | 35 | 145 | 170 | 135 | ⊚ | 58 | 50 | 120 | 0.5 | ⊚ |
| Ex. 44 | 15 | 35 | 146 | 171 | 136 | ⊚ | 58 | 50 | 120 | 0.5 | ⊚ |
| Ex. 45 | 15 | 50 | 132.5 | 172.5 | 122.5 | ⊚ | 58 | 55 | 125 | 0.2 | ⊚ |
| Ex. 46 | 15 | 45 | 138 | 173 | 128 | ⊚ | 58 | 52 | 122 | 0.2 | ⊚ |
| Ex. 47 | 15 | 40 | 145 | 175 | 135 | ⊚ | 58 | 50 | 119 | 0.2 | ⊚ |
| Ex. 48 | 15 | 30 | 154 | 174 | 144 | ◯ | 58 | 48 | 118 | 0.6 | ◯ |
| Ex. 49 | 15 | 90 | 91 | 171 | 81 | ◯ | 66 | 75 | 158 | 0.6 | ◯ |
| Ex. 50 | 15 | 30 | 151 | 171 | 141 | ⊚ | 50 | 45 | 110 | 0.3 | ⊚ |
| Ex. 51 | 15 | 25 | 156 | 171 | 146 | ⊚ | 37 | 32 | 89 | 0.3 | ⊚ |
| Ex. 52 | 15 | 36, then dried to 0 | 175 | 170 | 173 | ⊚ | 56 | 51 | 120 | 0.3 | ⊚ |
| Ex. 53 | 15 | 31, then dried to 0 | 175 | 170 | 173 | ⊚ | 56 | 52 | 118 | 0.3 | ⊚ |

TABLE 5

| | Cellulose acylate dope | | | | | | |
|---|---|---|---|---|---|---|---|
| | | | | | Total acyl | | |
| | Solvent | | | | degree of | Additives | |
| | | Composition | | Composition | cellulose | Releasing | Amount |
| | Main solvent | [mass %] | Alcohol | [mass %] | acetate | promoter | [ppm] |
| Comp. Ex. 101 | Methylene chloride | 80 | Ethanol | 20 | 1.90 | Nothing | |
| Ex. 101 | Methylene chloride | 80 | Ethanol | 20 | 2.10 | Nothing | |
| Ex. 102 | Methylene chloride | 80 | Ethanol | 20 | 2.30 | Nothing | |
| Ex. 103 | Methylene chloride | 80 | Ethanol | 20 | 2.42 | Nothing | |
| Ex. 104 | Methylene chloride | 80 | Ethanol | 20 | 2.42 | Nothing | |
| Ex. 105 | Methylene chloride | 80 | Ethanol | 20 | 2.55 | Nothing | |
| Ex. 106 | Methylene chloride | 80 | Ethanol | 20 | 2.65 | Nothing | |
| Comp. Ex. 102 | Methylene chloride | 80 | Ethanol | 20 | 2.75 | Nothing | |
| Comp. Ex. 103 | Methylene chloride | 80 | Ethanol | 20 | 2.42 | Nothing | |
| Comp. Ex. 104 | Melhylene chloride | 80 | Ethanol | 20 | 2.42 | Nothing | |
| Ex. 107 | Methylene chloride | 80 | Ethanol | 20 | 2.42 | Nothing | |
| Ex. 108 | Methylene chloride | 80 | Ethanol | 20 | 2.42 | Nothing | |
| Ex. 109 | Methylene chloride | 80 | Ethanol | 20 | 2.42 | Nothing | |
| Ex. 110 | Methylene chloride | 80 | Ethanol | 20 | 2.42 | Nothing | |
| Ex. 111 | Methylene chloride | 87 | Ethanol | 13 | 2.42 | Nothing | |
| Ex. 112 | Methylene chloride | 87 | Ethanol | 13 | 2.42 | Nothing | |
| Ex. 113 | Methylene chloride | 87 | Ethanol | 13 | 2.42 | Nothing | |
| Ex. 114 | Methylene chloride | 87 | Ethanol | 13 | 2.42 | Nothing | |
| Comp. Ex. 105 | Methylene chloride | 87 | Ethanol | 13 | 2.42 | Nothing | |
| Ex. 115 | Methylene chloride | 87 | Ethanol | 13 | 2.30 | HK | 300 |
| Ex. 116 | Methylene chloride | 87 | Ethanol | 13 | 2.42 | HK | 300 |
| Ex. 117 | Methylene chloride | 87 | Ethanol | 13 | 2.50 | HK | 300 |
| Ex. 118 | Methylene chloride | 87 | Ethanol | 13 | 2.42 | HK2 | 20000 |
| Ex. 119 | Methylene chloride | 87 | Ethanol | 13 | 2.42 | HK2 | 20000 |
| Ex. 120 | Methylene chloride | 87 | Ethanol | 13 | 2.42 | HK2 | 20000 |
| Ex. 121 | Methylene chloride | 87 | Ethanol | 13 | 2.42 | HK2 | 2000 |
| Ex. 122 | Methylene chloride | 87 | Ethanol | 13 | 2.42 | HK2 | 500 |
| Ex. 123 | Methylene chloride | 87 | Ethanol | 13 | 2.42 | HK3 | 20000 |
| Ex. 124 | Methylene chloride | 87 | Ethanol | 13 | 2.42 | HK4 | 20000 |
| Ex. 125 | Methylene chloride | 87 | Ethanol | 13 | 2.42 | HK5 | 20000 |
| Ex. 126 | Methylene chloride | 87 | Ethanol | 13 | 2.42 | HK6 | 20000 |
| Ex. 127 | Methylene chloride | 87 | Ethanol | 13 | 2.42 | HK7 | 20000 |
| Ex. 128 | Methylene chloride | 85 | Ethanol | 15 | 2.42 | Nothing | |
| Ex. 129 | Methylene chloride | 85 | Ethanol | 15 | 2.42 | Nothing | |
| Ex. 130 | Methylene chloride | 85 | Ethanol | 15 | 2.42 | Nothing | |
| Ex. 131 | Methylene chloride | 85 | Ethanol | 15 | 2.42 | Nothing | |
| Ex. 132 | Methylene chloride | 85 | Ethanol | 15 | 2.42 | Nothing | |
| Ex. 133 | Methylene chloride | 85 | Ethanol | 15 | 2.42 | Nothing | |
| Ex. 134 | Methylene chloride | 85 | Ethanol | 15 | 2.42 | Nothing | |
| Ex. 135 | Methylene chloride | 85 | Ethanol | 15 | 2.42 | Nothing | |
| Ex. 136 | Methylene chloride | 85 | Ethanol | 15 | 2.42 | Nothing | |
| Ex. 137 | Methylene chloride | 85 | Ethanol | 15 | 2.42 | Nothing | |
| Comp. Ex. 106 | Methylene chloride | 80 | Ethanol | 20 | 2.42 | Nothing | |
| Ex. 138 | Methylene chloride | 80 | Ethanol | 20 | 2.42 | Nothing | |
| Ex. 139 | Methylene chloride | 80 | Ethanol | 20 | 2.42 | Nothing | |
| Ex. 140 | Methylene chloride | 80 | Ethanol | 20 | 2.42 | Nothing | |
| Ex. 141 | Methylene chloride | 80 | Ethanol | 20 | 2.42 | Nothing | |

| | Cellulose acylate dope | | | | |
|---|---|---|---|---|---|
| | | | | | Solids |
| | Additives | | | | concentration |
| | Rth | | | | in dope at dope |
| | controlling | Amount | Additives | Amount | preperation |
| | agent | [mass %] | 2 | [mass %] | [mass %] |
| Comp. Ex. 101 | B | 19 | | | 21 |
| Ex. 101 | B | 19 | | | 21 |
| Ex. 102 | B | 19 | | | 21 |
| Ex. 103 | B | 19 | | | 21 |
| Ex. 104 | B | 19 | | | 21 |
| Ex. 105 | B | 19 | | | 21 |
| Ex. 106 | B | 19 | | | 21 |
| Comp. Ex. 102 | B | 19 | | | 21 |
| Comp. Ex. 103 | B | 19 | | | 21 |
| Comp. Ex. 104 | B | 19 | | | 21 |
| Ex. 107 | B | 19 | | | 21 |
| Ex. 108 | B | 19 | | | 21 |
| Ex. 109 | B | 19 | | | 21 |
| Ex. 110 | B | 19 | | | 21 |
| Ex. 111 | B | 19 | | | 21 |
| Ex. 112 | B | 19 | | | 21 |
| Ex. 113 | B | 19 | | | 21 |
| Ex. 114 | B | 19 | | | 21 |
| Comp. Ex. 105 | B | 19 | | | 21 |
| Ex. 115 | B | 19 | | | 21 |
| Ex. 116 | B | 19 | | | 21 |
| Ex. 117 | B | 19 | | | 21 |
| Ex. 118 | B | 19 | | | 21 |
| Ex. 119 | B | 17 | | | 21 |
| Ex. 120 | B | 15 | | | 21 |
| Ex. 121 | B | 17 | | | 21 |
| Ex. 122 | B | 17 | | | 21 |
| Ex. 123 | B | 17 | | | 21 |
| Ex. 124 | B | 17 | | | 21 |
| Ex. 125 | B | 17 | | | 21 |
| Ex. 126 | B | 17 | | | 21 |
| Ex. 127 | B | 17 | | | 21 |
| Ex. 128 | B | 10 | | | 21 |
| Ex. 129 | B | 15 | | | 21 |
| Ex. 130 | B | 25 | | | 21 |
| Ex. 131 | A | 15 | | | 21 |
| Ex. 132 | C | 15 | | | 21 |
| Ex. 133 | D | 15 | | | 21 |
| Ex. 134 | E | 15 | | | 21 |
| Ex. 135 | F | 15 | AA | 1 | 21 |
| Ex. 136 | G | 15 | AB | 2 | 21 |
| Ex. 137 | H | 15 | AC | 1.5 | 21 |
| Comp. Ex. 106 | B | 19 | | | 16 |
| Ex. 138 | B | 19 | | | 18 |
| Ex. 139 | B | 19 | | | 20 |
| Ex. 140 | B | 19 | | | 22 |
| Ex. 141 | B | 19 | | | 24 |

| | | | | Film property | | | | | | | |
|---|---|---|---|---|---|---|---|---|---|---|---|
| | Condition of film peeling | | | | | | Thickness | | | | |
| | Roll | Residual | Stretching | | | | after | | | | |
| | temperature | solvent | temperature | Tm | Te | Peeling | stretching | Re | Rth | haze | Total |
| | [° C.] | [mass %] | [° C.] | [° C.] | [° C.] | aptitude | [μm] | [nm] | [nm] | [%] | evaluation |
| Comp. Ex. 101 | −7 | 36 | 148 | 182 | 146 | X | 58 | — | — | — | X |
| Ex. 101 | −7 | 36 | 148 | 182 | 146 | ◯ | 58 | 65 | 157 | 0.3 | ◯ |
| Ex. 102 | −7 | 36 | 142 | 176 | 140 | ⊚ | 58 | 56 | 135 | 0.3 | ⊚ |
| Ex. 103 | −7 | 36 | 136 | 170 | 134 | ⊚ | 58 | 50 | 119 | 0.3 | ⊚ |
| Ex. 104 | −7 | 36, then dried to 0 | 172 | 170 | 170 | ⊚ | 58 | 51 | 121 | 0.4 | ⊚ |
| Ex. 105 | −7 | 36 | 131 | 165 | 129 | ⊚ | 58 | 46 | 110 | 0.3 | ⊚ |
| Ex. 106 | −7 | 36 | 126 | 160 | 124 | ⊚ | 58 | 38 | 92 | 0.3 | ⊚ |
| Comp. Ex. 102 | −7 | 35 | 125 | 158 | 123 | ⊚ | 58 | 18 | 75 | 0.9 | X |
| Comp. Ex. 103 | 15 | 35 | 137 | 170 | 135 | XX | 58 | — | — | — | XX |
| Comp. Ex. 104 | 11 | 35 | 137 | 170 | 135 | X | 58 | — | — | — | X |
| Ex. 107 | 7 | 35 | 137 | 170 | 135 | ◯ | 58 | 49 | 118 | 0.6 | ◯ |
| Ex. 108 | 0 | 35 | 137 | 170 | 135 | ⊚ | 58 | 49 | 118 | 0.3 | ⊚ |
| Ex. 109 | −5 | 35 | 137 | 170 | 135 | ⊚ | 58 | 50 | 119 | 0.3 | ⊚ |
| Ex. 110 | −15 | 35 | 137 | 170 | 135 | ⊚ | 58 | 50 | 120 | 0.3 | ⊚ |
| Ex. 111 | −5 | 30 | 144 | 172 | 142 | ◯ | 41 | 40 | 96 | 0.6 | ◯ |
| Ex. 112 | −5 | 50 | 124 | 172 | 122 | ◯ | 54 | 42 | 100 | 0.6 | ◯ |
| Ex. 113 | −5 | 70 | 104 | 172 | 102 | ◯ | 60 | 52 | 125 | 0.6 | ◯ |
| Ex. 114 | −5 | 80 | 94 | 172 | 92 | ◯ | 68 | 56 | 135 | 0.6 | ◯ |
| Comp. Ex. 105 | −5 | 110 | 64 | 172 | 62 | X | 95 | — | — | — | X |
| Ex. 115 | −5 | 35 | 145 | 178 | 143 | ◯ | 58 | 50 | 119 | 0.6 | ◯ |
| Ex. 116 | −5 | 35 | 138 | 171 | 136 | ◯ | 58 | 50 | 119 | 0.6 | ◯ |
| Ex. 117 | −5 | 35 | 131 | 164 | 129 | ◯ | 58 | 50 | 119 | 0.7 | ◯ |
| Ex. 118 | −5 | 40 | 134 | 172 | 132 | ⊚ | 58 | 50 | 119 | 0.3 | ⊚ |
| Ex. 119 | −5 | 41 | 136 | 175 | 134 | ⊚ | 57 | 50 | 119 | 0.3 | ⊚ |
| Ex. 120 | −5 | 42 | 137 | 177 | 135 | ⊚ | 56 | 50 | 119 | 0.3 | ⊚ |
| Ex. 121 | −5 | 45 | 132 | 175 | 130 | ◯ | 56 | 50 | 119 | 0.3 | ◯ |
| Ex. 122 | −5 | 41 | 136 | 175 | 134 | ▴ | 54 | 50 | 119 | 0.3 | ▴ |
| Ex. 123 | −5 | 41 | 133 | 172 | 131 | ⊚ | 57 | 50 | 119 | 0.3 | ⊚ |
| Ex. 124 | −5 | 40 | 134 | 172 | 132 | ⊚ | 58 | 50 | 119 | 0.3 | ⊚ |
| Ex. 125 | −5 | 41 | 133 | 172 | 131 | ⊚ | 56 | 50 | 119 | 0.3 | ⊚ |
| Ex. 126 | −5 | 42 | 132 | 172 | 130 | ⊚ | 55 | 50 | 119 | 0.3 | ⊚ |
| Ex. 127 | −5 | 41 | 133 | 172 | 131 | ⊚ | 57 | 50 | 119 | 0.3 | ⊚ |
| Ex. 128 | −6 | 35 | 152 | 185 | 150 | ◯ | 58 | 63 | 152 | 0.6 | ◯ |
| Ex. 129 | −6 | 35 | 143 | 176 | 141 | ⊚ | 58 | 56 | 135 | 0.4 | ⊚ |
| Ex. 130 | −6 | 35 | 132 | 165 | 130 | ⊚ | 58 | 46 | 110 | 0.3 | ⊚ |
| Ex. 131 | −5 | 35 | 143 | 176 | 141 | ◯ | 58 | 50 | 119 | 0.8 | ◯ |
| Ex. 132 | −5 | 35 | 142 | 175 | 140 | ◯ | 57 | 50 | 119 | 0.7 | ◯ |
| Ex. 133 | −5 | 34 | 144 | 176 | 142 | ◯ | 56 | 50 | 119 | 0.6 | ◯ |
| Ex. 134 | −5 | 32 | 148 | 178 | 146 | ◯ | 55 | 50 | 119 | 0.5 | ◯ |
| Ex. 135 | −5 | 41 | 135 | 174 | 133 | ◯ | 58 | 50 | 119 | 0.2 | ◯ |
| Ex. 136 | −5 | 38 | 136 | 172 | 134 | ◯ | 54 | 50 | 119 | 0.4 | ◯ |
| Ex. 137 | −5 | 35 | 137 | 170 | 135 | ◯ | 56 | 50 | 119 | 0.3 | ◯ |
| Comp. Ex. 106 | −10 | 105 | 70 | 173 | 68 | X | 58 | — | — | — | X |
| Ex. 138 | −10 | 80 | 96 | 174 | 94 | ◯ | 58 | 44 | 105 | 0.7 | ◯ |
| Ex. 139 | −10 | 40 | 134 | 172 | 132 | ⊚ | 58 | 46 | 110 | 0.2 | ⊚ |
| Ex. 140 | −10 | 30 | 148 | 176 | 146 | ⊚ | 58 | 45 | 109 | 0.3 | ⊚ |
| Ex. 141 | −10 | 30 | 147 | 175 | 145 | ⊚ | 58 | 52 | 125 | 0.3 | ⊚ |

From Table 3 and Table 4, it is known that the invention provides a cellulose acetate film having good Rth expressibility, which is easy to peel from the support in solution casting.

On the other hand, in Comparative Examples 1 and 3, the degree of total acyl substitution of the cellulose acetate used was lower than the scope of the invention, and the peeling aptitude of the obtained film was not good, and the film could not be analyzed for determining its optical properties and haze. In Comparative Examples 2 and 4, the degree of total acyl substitution of the cellulose acetate used was higher than the scope of the invention, and the Rth expressibility of the obtained film was not good. In Comparative Example 5, the mean carbon number of the alcohol used as the solvent was lower than the lowermost limit of the scope of the invention. With the solvent composition of methyl chloride/methanol, the obtained film had poor peeling aptitude, and could not be analyzed for determining its optical properties and haze. In Comparative Example 6, the mean carbon number of the alcohol used as the solvent was higher than the highest limit of the scope of the invention. The obtained film had poor peeling aptitude, and could not be analyzed for determining its optical properties and haze. In Comparative Example 7, the solvent composition of the dope had an ethanol content lower than the scope of the invention, and the obtained film had poor peeling aptitude and could not be analyzed for determining its,optical properties and haze.

From Table 5, it is known that the invention provides a cellulose acetate film having good Rth expressibility, which is easy to peel from the support in solution casting.

On the other hand, in Comparative Example 101, the degree of total acyl substitution of the cellulose acetate used was lower than the scope of the invention, and the peeling aptitude of the obtained film was not good, and the film could not be analyzed for determining its optical properties and haze. In Comparative Example 102, the degree of total acyl substitution of the cellulose acetate used was higher than the scope of the invention, and the Rth expressibility of the obtained film was not good. In Comparative Examples 103 and 104, the surface temperature of the cooling unit (roll) kept in contact with the support in the film peeling region was higher than the scope of the invention, and the obtained film had poor peeling aptitude, and could not be analyzed for determining its optical properties and haze. In Comparative Examples 105 and 106, the residual solvent amount in the dope was higher than the scope of the invention, and the obtained film had poor peeling aptitude, and could not be analyzed for determining its optical properties and haze.

The present disclosure relates to the subject matter contained in Japanese Patent Application No. 027608/2010 filed on Feb. 10, 2010, Japanese Patent Application No. 048891/2010 filed on Mar. 5, 2010 and Japanese Patent Application No. 054051/2010 filed on Mar. 11, 2010 which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for producing a cellulose acetate film comprising:
casting a dope comprising a cellulose acetate and a solvent on a support to prepare a dope film, wherein the total substitution degree of the cellulose acetate is from 2.0 to 2.7; and
peeling away the dope film from the support.

2. The method for producing a cellulose acetate film according to claim 1, wherein the solvent comprises an alcohol in an amount of 15% or more by mass and the average carbon number of the alcohol is from 1.5 to 4.

3. The method for producing a cellulose acetate film according to claim 2, wherein the alcohol comprises ethanol.

4. The method for producing a cellulose acetate film according to claim 2, wherein the support is a moving strip-shaped support, and in the region where the dope film is peeled away from the support, the support is kept in contact with a cooling unit having a surface temperature of 10° C. or lower, on the side thereof opposite to the side from which the dope film is peeled away.

5. The method for producing a cellulose acetate film according to claim 1, wherein the residual solvent amount is controlled to be at most 100% at the time when the dope film is peeled away, and in the region where the dope film is peeled away from the support, the support is kept in contact with a cooling unit having a surface temperature of 10° C. or lower, on the side thereof opposite to the side from which the dope film is peeled away.

6. The method for producing a cellulose acetate film according to claim 5, wherein the total substitution degree of the cellulose acetate is from 2.1 to 2.6.

7. The method for producing a cellulose acetate film according to claim 5, wherein the residual solvent amount is controlled to be at most 55% at the time when the dope is peeled away from the support.

8. The method for producing cellulose acetate film according to claim 5, wherein the surface temperature of the cooling unit is −5° C. or lower.

9. The method for producing cellulose acetate film according to claim 5, wherein the dope comprises at least one alcohol having 2 or more carbon atoms as the solvent, and the total content of the alcohol to the total mass of the solvent is from 10 to 40% by mass.

10. The method for producing a cellulose acetate film according to claim 5, wherein the dope comprises ethanol as the solvent, and the total content of the ethanol to the total mass of the solvent is from 10 to 40% by mass.

11. The method for producing cellulose acetate film according to claim 1, wherein the dope includes a release promoter.

12. The method for producing a cellulose acetate film according to claim 11, wherein the release promoter is an organic acid represented by the following formula (1) and the content of the release promoter to the cellulose acetate in the dope is from 0.001 to 20% by mass:
X-L-(R¹)ₙ Formula (1)
wherein:
X represents an acid group wherein the acid dissociation constant is 5.5 or less;
L represents a single bond, or a di- or more valent linking group;
R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms or a hetero ring group having from 6 to 30 carbon atoms, and each group may have a substituent;
n represents 1 in the case where L is a single bond, or represents the number expressed by:
(the valence number of L)−1
in the case where L is di- or more valent linking group.

13. The method for producing a cellulose acetate film according to claim 12, wherein the X in the formula (1) represents a carboxyl group, a sulfonic acid group, a sulfinic acid group, a phosphate group, a sulfonimide group or an ascorbic acid group.

14. The method for producing a cellulose acetate film according to claim 1, wherein the dope comprises an agent for controlling Rth that is the retardation in the thickness direction of the film.

15. The method for producing a cellulose acetate film according to claim 1, further comprising stretching the film at a temperature satisfying the following inequality (1):
Te−30° C.≦Stretching temperature≦Te+30° C. (1),
Te=T[tan δ]−ΔTm (1) (1′),
ΔTm=Tm(0)−Tm(x): (1″),
wherein:
T[tan δ] represents the temperature at which tan δ shows a peak in measurement of the dynamic viscoelasticity tan δ of cellulose acetate having a residual solvent amount of 0%;
Tm(0) represents the crystal melting temperature of the cellulose acetate having a residual solvent amount of 0%; and
Tm(x) represents the crystal melting temperature of the cellulose acetate having a residual solvent amount of x %.

16. A cellulose acetate film produced by the method for producing a cellulose acetate film of claim 1, having an Rth, that is a retardation in the thickness direction of the film, measured at the wave length of 590 nm is 80 nm or more.

17. The cellulose acetate film according to claim 16, having a haze of less than 0.5%.

18. The cellulose acetate film according to claim 16, having an Re, that is an in-plane retardation, measured at the wave length of 590 nm is from 30 to 100 nm.

19. A polarizer comprising a polarizing element and at least one sheet of the cellulose acetate film of claim 16.

20. A liquid crystal display device comprising at least one sheet of the cellulose acetate film of claim 16.
